(19) United States
(12) Patent Application Publication
(10) Pub. No.: US 2025/0373311 A1
(43) Pub. Date: Dec. 4, 2025

(54) ADAPTIVE PROCEDURE 3 (P-3) TRIGGERING AND TRAFFIC-BASED BEAM MANAGEMENT PROCEDURE TRIGGERING

(71) Applicant: Samsung Electronics Co., Ltd., Suwon-si (KR)

(72) Inventors: Mustafa Furkan Ozkoc, The Colony, TX (US); Jianhua Mo, Allen, TX (US); Hyejin Kim, Suwon-si (KR); Jeehwan Noh, Suwon-si (KR); Young Han Nam, Plano, TX (US); TaeYoung Kim, Suwon-si (KR)

(21) Appl. No.: 19/093,005

(22) Filed: Mar. 27, 2025

Related U.S. Application Data
(60) Provisional application No. 63/654,803, filed on May 31, 2024.
(60) Provisional application No. 63/665,135, filed on Jun. 27, 2024.

(51) Int. Cl. H04B 7/06

(52) U.S. Cl. CPC H04B 7/06952; H04B 7/0626

(57) ABSTRACT

A method and device for adaptive user equipment (UE) beam refinement procedure triggering and traffic-based beam management procedure training. A method comprises determining, via a base station (BS), that one or more trigger conditions have occurred. The method includes determining to trigger a UE beam refinement procedure based on determining that the trigger conditions have occurred, and transmitting a reference signal with repetitions for UE beam selection for the UE beam refinement procedure.

### CROSS-REFERENCE TO RELATED APPLICATION(S) AND CLAIM OF PRIORITY

This application claims priority under 35 U.S.C. § 119(e) to U.S. Provisional Patent Application No. 63/654,803, filed on May 31, 2024, and U.S. Provisional Patent Application No. 63/665,135, filed on Jun. 27, 2024, which are hereby incorporated by reference in their entireties.

### TECHNICAL FIELD

This disclosure relates generally to wireless communication, and more specifically to adaptive P-3 procedure triggering and traffic-based beam management procedure training.

### BACKGROUND

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60GHz bands, so as to accomplish higher data rates or in lower frequency bands, such as 6 GHZ, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

The mmWave beam codebook design is challenging for the 5G mmWave base stations (BSs). Unlike the low-frequency bands, beamforming is needed to support the high data transmission at the mmWave band due to the large mmWave band path loss. Many beams may be needed to cover a wide angular region, for example, horizontally from −60 degrees to +60 degrees. On the other hand, many reference signals are needed to find the best beam between BS and user equipment (UE).

### SUMMARY

Embodiments of the present disclosure provide methods and apparatuses for adaptive P-3 procedure triggering and traffic-based beam management procedure training.

In one embodiment, a method comprises determining, via a base station (BS), that one or more trigger conditions have occurred. The method includes determining to trigger a user equipment (UE) beam refinement procedure based on determining that the trigger conditions have occurred, and transmitting a reference signal with repetitions for UE beam selection for the UE beam refinement procedure.

In another embodiment, a BS comprises a processor configured to: determine that one or more trigger conditions have occurred, and determine to trigger a user equipment (UE) beam refinement procedure based on determining that the trigger conditions have occurred. The BS includes a transceiver operably coupled to the processor. The transceiver is configured to transmit a reference signal with repetitions for UE beam selection for the UE beam refinement procedure.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit”, “receive”, and “communicate” as well as derivatives thereof, encompass both direct and indirect communication. The terms “include” and “comprise”, as well as derivatives thereof, mean inclusion without limitation. The term “or” is inclusive, meaning and/or. The phrase “associated with”, as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIG. 4 illustrates an example of beam management procedures according to embodiments of the present disclosure;

FIG. 5 illustrates an example procedure for beam management and channel state information (CSI) measurement according to embodiments of the present disclosure;

FIG. 6 illustrates an example of a base station (BS) for triggering a P-3 procedure according to embodiments of the present disclosure;

FIG. 7 illustrates an example of a method for periodic P-3 triggering according to embodiments of the present disclosure;

FIG. 8 illustrates an example of a method for P-3 triggering after P-2 according to embodiments of the present disclosure;

FIG. 9 illustrates an example of a method for P-3 triggering after P-2 with a delay according to embodiments of the present disclosure;

FIG. 10 illustrates an example of a method for P-3 triggering after P-2 when the serving network narrow beam is changed according to embodiments of the present disclosure;

FIG. 11 illustrates an example of a method for P-3 triggering after P-2 when the serving network wide beam is changed according to embodiments of the present disclosure;

FIG. 12 illustrates an example of a method for P-3 triggering after P-2 when either the serving network narrow beam or the serving network wide beam is changed according to embodiments of the present disclosure;

FIG. 13 illustrates an example of a method for P-3 triggering after P-2 when both the serving network narrow beam and the serving network wide beam are changed according to embodiments of the present disclosure;

FIG. 14 illustrates an example of a method for P-3 triggering with CSI measurement where CSI measurement is performed before P-3 according to embodiments of the present disclosure;

FIG. 15 illustrates an example of a method for P-3 triggering with CSI measurement where P-3 is performed before CSI measurement according to embodiments of the present disclosure;

FIG. 16 illustrates an example of a method for P-3 triggering when the reported narrow beam reference signal received power (RSRP) is higher than a threshold according to embodiments of the present disclosure;

FIG. 17 illustrates an example of a method for P-3 triggering when the reported narrow beam RSRP is lower than a threshold according to embodiments of the present disclosure;

FIG. 18 illustrates an example of a method for P-3 triggering when the reported wide beam RSRP is higher than a threshold according to embodiments of the present disclosure;

FIG. 19 illustrates an example of a method for P-3 triggering when the reported wide beam RSRP is lower than a threshold according to embodiments of the present disclosure;

FIG. 20 illustrates an example of a method for P-3 triggering when the reported rank indication is equal to two according to embodiments of the present disclosure;

FIG. 21 illustrates an example of a traffic-based scheme which skips P-3 if there is no traffic according to embodiments of the present disclosure;

FIG. 22 illustrates an example of a method of a traffic-based scheme which skips P-3 if there is no traffic according to embodiments of the present disclosure;

FIGS. 23A and 23B illustrate examples of loss duration where the traffic is on but P-3 is off according to embodiments of the present disclosure;

FIG. 24 illustrates an example of a hysteresis scheme to enable P-3 triggering for some time even after the traffic is off according to embodiments of the present disclosure;

FIG. 25 illustrates an example of a method of a hysteresis scheme to enable P-3 triggering for some time even after the traffic is off according to embodiments of the present disclosure;

FIG. 26 illustrates an example of a keep alive scheme to trigger P-3 when the traffic is off for a long duration according to embodiments of the present disclosure;

FIG. 27 illustrates an example of a method of a keep alive scheme to trigger P-3 when the traffic is off for a long duration according to embodiments of the present disclosure;

FIG. 28 illustrates an example of a traffic arrival scheme to trigger P-3 when the traffic is off for a long duration according to embodiments of the present disclosure;

FIG. 29 illustrates an example of a method of a traffic arrival scheme to trigger P-3 when the traffic is off for a long duration according to embodiments of the present disclosure;

FIG. 30 illustrates an example of a method of a traffic arrival scheme where the traffic arrival P-3 is triggered when the last P-3 has passed for a certain amount of time according to embodiments of the present disclosure;

FIG. 31 illustrates an example of a method of a combination of hysteresis and keep alive scheme according to embodiments of the present disclosure; and

FIG. 32 illustrates an example method for UE beam refinement procedure triggering according to embodiments of the present disclosure.

### DETAILED DESCRIPTION

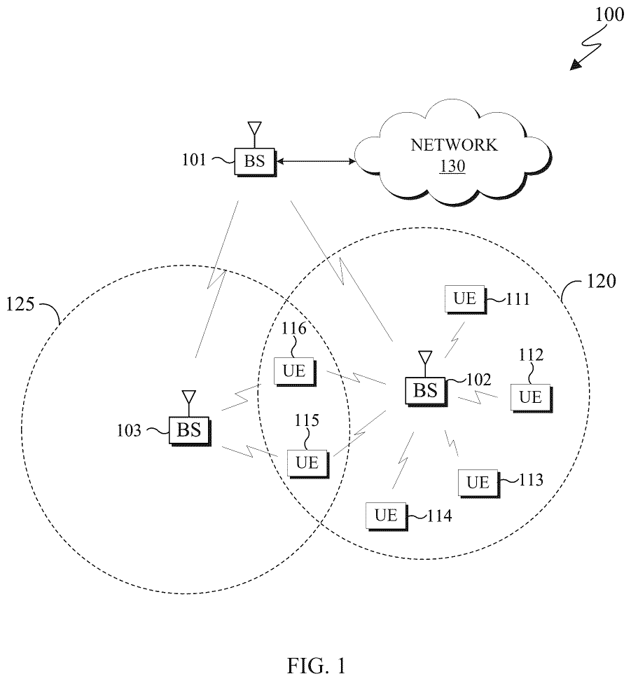

FIGS. 1 through 32, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Embodiments of the present disclosure recognize that in some systems, the P-3 channel state information reference signal (CSI-RS) could be transmitted over a single port, enabling the UE to determine the best beam based on RSRP. In some systems, the P-3 CSI-RS could be transmitted over two ports, enabling the UE to determine the best beam based on spectral efficiency (SE). Moreover, in some cases, the P-3 procedure incurs overhead in the downlink, because of the resource allocation to the P-3 CSI-RS signaling. In addition, the P-3 procedure is executed for every user. When there are many users, the P-3 overhead could significantly reduce the downlink throughput.

Accordingly, various embodiments of the present disclosure can provide methods and apparatuses for low-overhead beam tracking for mobile terminals. Further, various embodiments of the present disclosure can provide triggering a UE beam selection procedure or P-3 via a base station based on network information and trigger conditions to facilitate a UE to determine its optimal beam. In addition, various embodiments of the present disclosure can provide utilizing a hysteresis scheme to enable a UE beam selection procedure or P-3 for a time duration after traffic is off and, when traffic is off, causing a BS to trigger a UE beam selection procedure or P-3 if a current time is within a specified proximity threshold of a most recent time that traffic was on. Further, various embodiments of the present disclosure can provide utilizing a keep-alive scheme to trigger a P-3 when a most recent P-3 measurement was performed and exceeds a threshold duration ago. Further still, various embodiments of the present disclosure can provide causing the BS to trigger P-3 when traffic arrives, wherein triggering P-3 reduces performance loss at a beginning of a traffic-on duration.

Although mmWave bands are used as an example in this disclosure, the embodiments in this disclosure can also be applied to other frequency bands as well. It is noted that although a focus in the present disclosure is on the reference signal received power (RSRP) and spectral efficiency (SE), the UE measurements of the channel could be reference signal received quality (RSRQ), channel quality indicator (CQI), signal-to-noise-ratio (SNR), signal-to-interference-noise-ratio (SINR), etc. The embodiments in this disclosure can be applied to those measurement metrics as well.

A BS using the P-3 can increase the SE by facilitating the UE to determine its best beam. The P-3 CSI-RS could incur overhead in the system. In the downlink, part of the overhead could be due to the transmission of downlink control information (DCI), and part of the overhead could be due to the transmission of CSI-RS. The increased overhead could occupy downlink resources and reduce the data transmission opportunity. There is a trade-off between the potential SE improvement and the lost transmission opportunity due to P-3. The present disclosure provides several P-3 triggering methods to achieve the best trade-off.

Some of the beam management procedures, for example, P-3, could be triggered only when there is traffic. By doing so, the downlink signaling overhead can be reduced without much performance loss in suitable scenarios.

Some of the triggering conditions to facilitate a UE to determine its optimum beam include, but are not limited to: trigger P-3 periodically; trigger P-3 after each P-2; trigger P-3 after each CSI measurement; trigger P-3 before each CSI measurement; trigger P-3 after each P-2 if the current rank indication is two; trigger P-3 after each CSI measurement if the reported rank indication is two; trigger P-3 after each P-2 if the network narrow beam (NB) is changed; trigger P-3 after each P-2 if the SE estimate is higher than maximum SE achievable by rank indication 1; and trigger P-3 after each P-2 if the SE estimate is lower than maximum SE achievable by rank indication 1.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station”, “subscriber station”, “remote terminal”, “wireless terminal”, “receive point”, or “user device”. For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

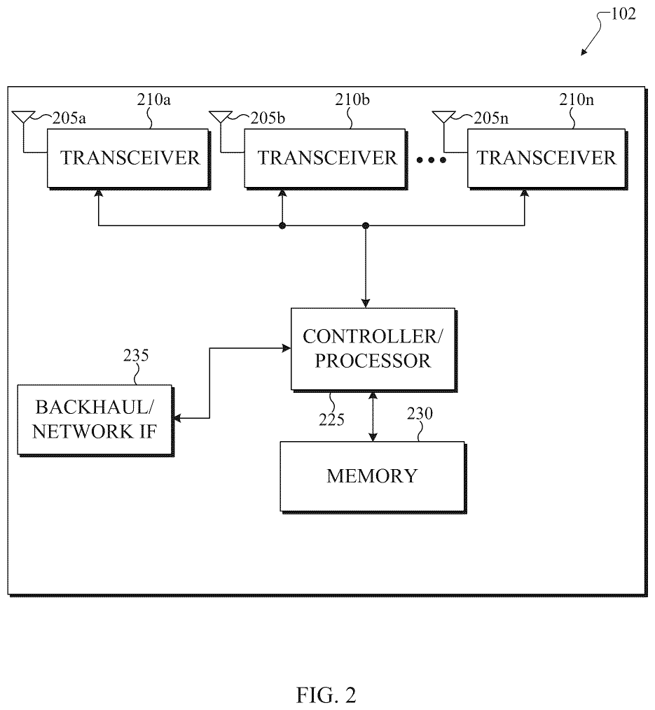

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-convert the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 or the transceivers 210a-210n may include circuitry and/or programming for facilitating adaptive UE P-3 triggering and traffic-based beam management procedure training. The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

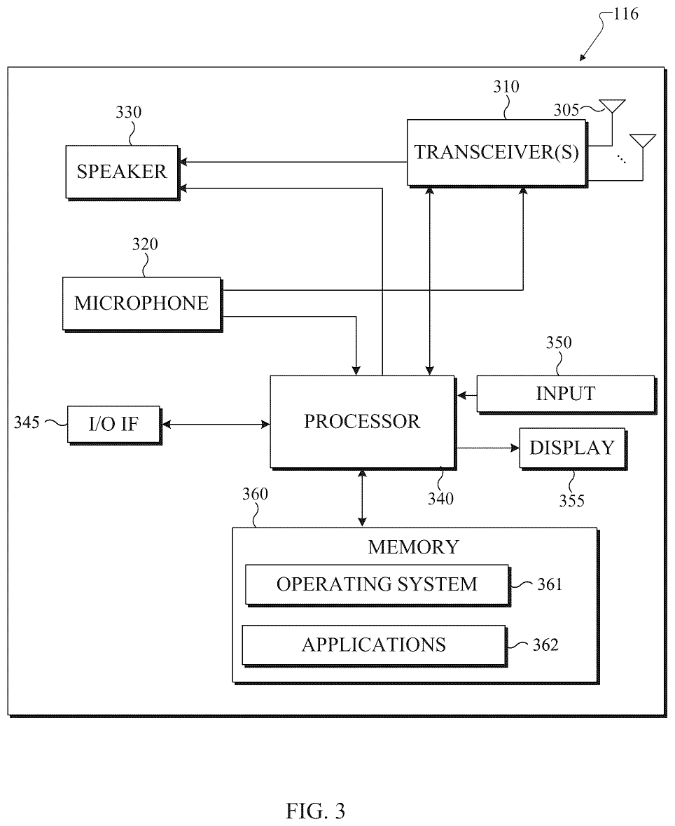

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 can include circuitry and/or programming for facilitating adaptive P-3 triggering and traffic-based beam management procedure training. The processor 340 is also capable of executing other processes and programs resident in the memory 360. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

A mmWave beam management comprises three procedures: Procedure 1 (P-1), Procedure 2 (P-2), and Procedure 3 (P-3). In P-1, a BS sweeps its wide beams, while a UE determines which wide beam is the best one. In P-2, a BS sweeps the narrow beams aligned or close to the wide beam found in P-1, and the UE determines the best narrow beam. In P-3, a BS repeats transmission on the narrow beam identified in P-2, while a UE sweeps its beams and decides its best beam to communicate with the BS. As used herein P-3 may also be referred to as a UE beams selection or refinement procedure.

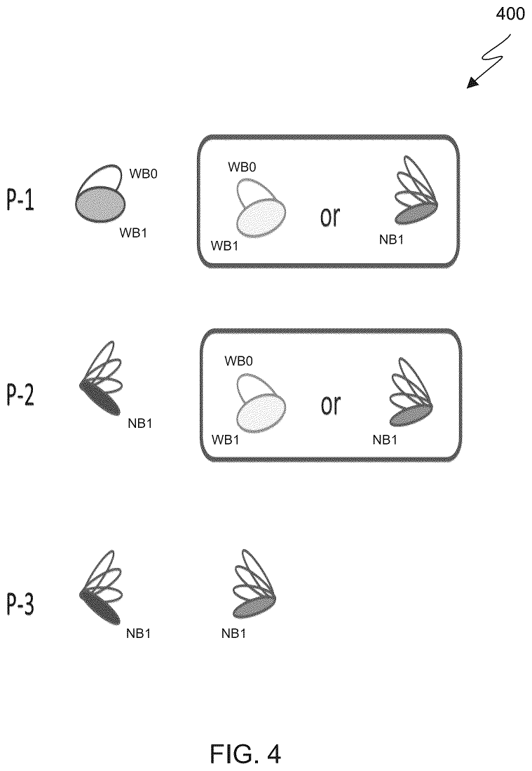

FIG. 4 illustrates an example of beam management procedures 400 according to embodiments of the present disclosure. For example, beam management procedures 400 can be implemented by the gNB 102 and any of the UEs 111-116 of FIG. 1. The embodiment of the example beam management procedures 400 shown in FIG. 4 is for illustration only. Other embodiments of the example beam management procedures 400 could be used without departing from the scope of this disclosure.

As illustrated in FIG. 4, during P-1 and P-2, a UE could utilize its wide beams or its narrow beams. During P-3, typically the UE will utilize its narrow beams.

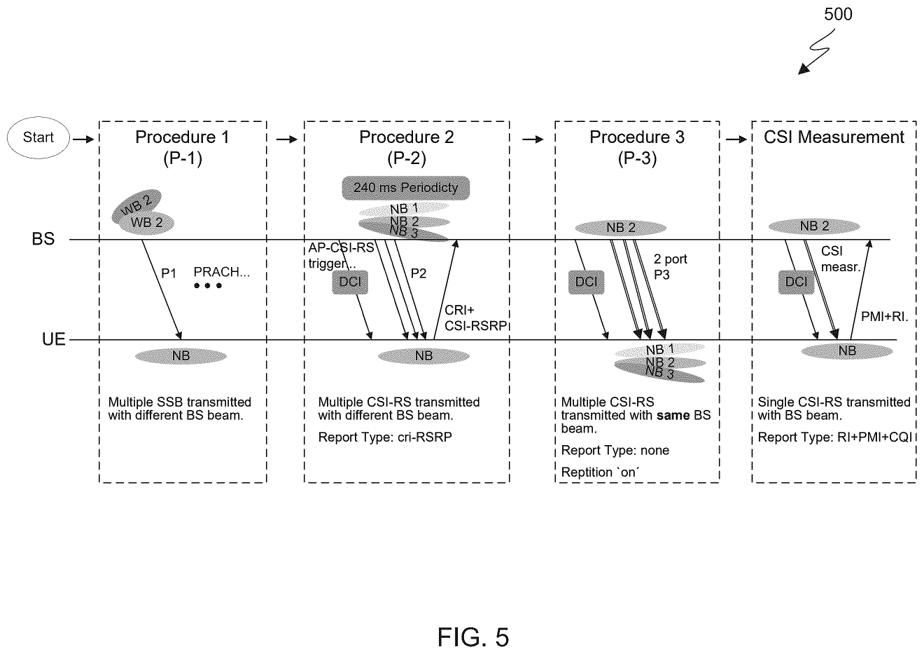

FIG. 5 illustrates an example procedure 500 for beam management and CSI measurement according to embodiments of the present disclosure. For example, procedure 500 can be performed by the UE 116 and the gNB 102 and/or network 130 in the wireless network 100 of FIG. 1. The embodiment of the example procedure 500 for beam management and CSI measurement shown in FIG. 5 is for illustration only. Other embodiments of the example procedure 500 for beam management and CSI measurement could be used without departing from the scope of this disclosure.

In some systems, the P-3 channel state information reference signal (CSI-RS) could be transmitted over a single port, enabling the UE to determine the best beam based on RSRP. In some systems, the P-3 CSI-RS could be transmitted over two ports, enabling the UE to determine the best beam based on spectral efficiency (SE). Moreover, in some cases, the P-3 procedure incurs overhead in the downlink, because of the resource allocation to the P-3 CSI-RS signaling. In addition, the P-3 procedure is executed for every user. When there are many users, the P-3 overhead could significantly reduce the downlink throughput.

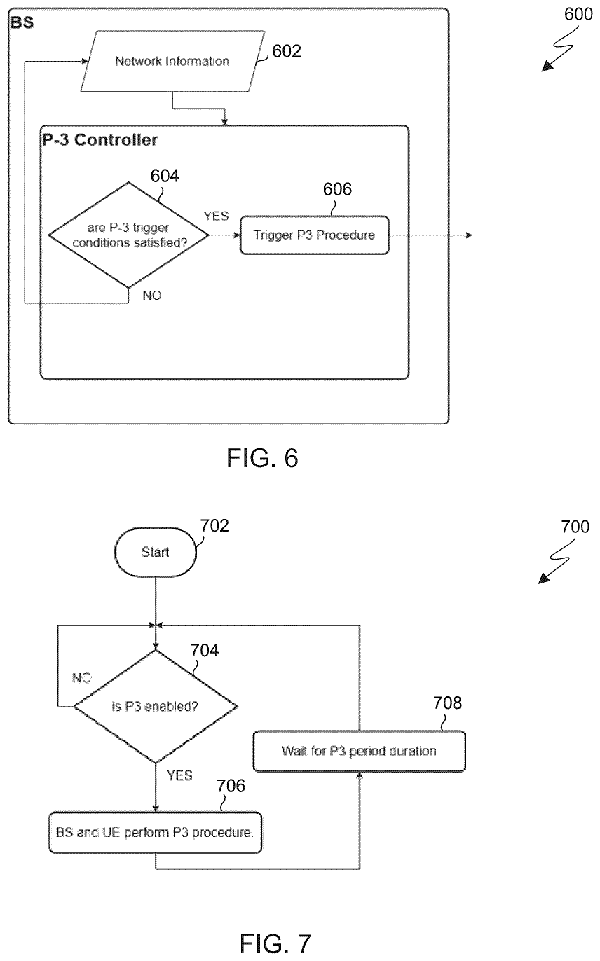

FIG. 6 illustrates an example of a BS for triggering a P-3 procedure 600 according to embodiments of the present disclosure. For example, the BS can be the BS 102 of FIG. 2. The embodiment of the example of a BS for triggering a P-3 procedure 600 shown in FIG. 6 is for illustration only. Other embodiments of the example of a BS for triggering a P-3 procedure 600 could be used without departing from the scope of this disclosure.

The conditions, periodicity, or timing of triggering the P-3 could be determined by a BS. As illustrated in FIG. 6, in some embodiments the BS could determine the P-3 trigger conditions and the timing based on network information. Some examples of such information could be: other beam management timers such as a P-2 timer, other periodic signals such as SSB transmissions, other channel measurement events such as CSI measurement timers, current network state such as serving network wide beam, serving network narrow beam, the channel quality of the user, such as the RSRP, and CQI, reported by the user, information received from the UE reports of other beam management procedures such as a P-2 report, status of UE downlink traffic buffer, information related to UE uplink traffic status or scheduling requests made by the UE, the number of connected users in the network, priority of each user, total network traffic load.

FIG. 7 illustrates an example of a method 700 for periodic P-3 triggering according to embodiments of the present disclosure. For example, method 700 can be performed by the UE 116 and the gNB 102 and/or network 130 in the wireless network 100 of FIG. 1. The embodiment of the example of a method 700 for periodic P-3 triggering shown in FIG. 7 is for illustration only. Other embodiments of the example of a method 700 for periodic P-3 triggering could be used without departing from the scope of this disclosure.

As illustrated in FIG. 7, the method 700 begins at step 702, and proceeds to step 704, where a determination is made whether P-3 is enabled. If P-3 is enabled, then at step 706, the BS and the UE perform the P-3 procedure, and thereafter wait for a P-3 period duration at step 708 before performing the P-3 procedure again.

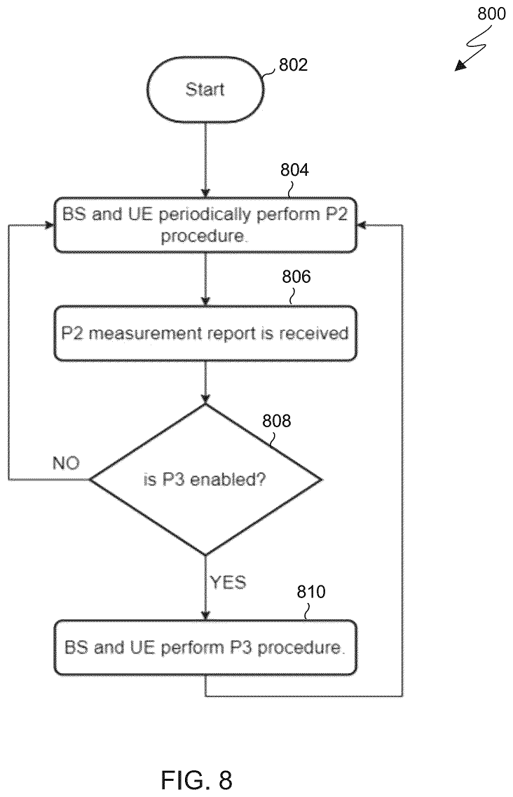

FIG. 8 illustrates an example of a method 800 for P-3 triggering after P-2 according to embodiments of the present disclosure. For example, method 800 can be performed by the UE 116 and the gNB 102 and/or network 130 in the wireless network 100 of FIG. 1. The embodiment of the example of a method 800 for P-3 triggering after P-2 shown in FIG. 8 is for illustration only. Other embodiments of the example of a method 800 for P-3 triggering after P-2 could be used without departing from the scope of this disclosure.

In some embodiments, P-3 can be triggered after every P-2. In some systems, a BS could trigger P-2 periodically for each UE. Therefore, if P-2 is periodic, when P-3 is triggered after every P-2, the P-3 could also have the same periodicity as the P-2. An example flow of such a triggering method is illustrated in FIG. 8.

As illustrated in FIG. 8, the method 800 begins at step 802, and proceeds to step 804, where the BS and the UE periodically perform the P-2 procedure. At step 806, a P-2 measurement report is received, and thereafter a determination is made at step 808 whether P-3 is enabled. If P-3 is not enabled, then the method reverts to step 804. If P-3 is enabled, then at step 810, the BS and the UE perform the P-3 procedure, and thereafter the method reverts to step 804.

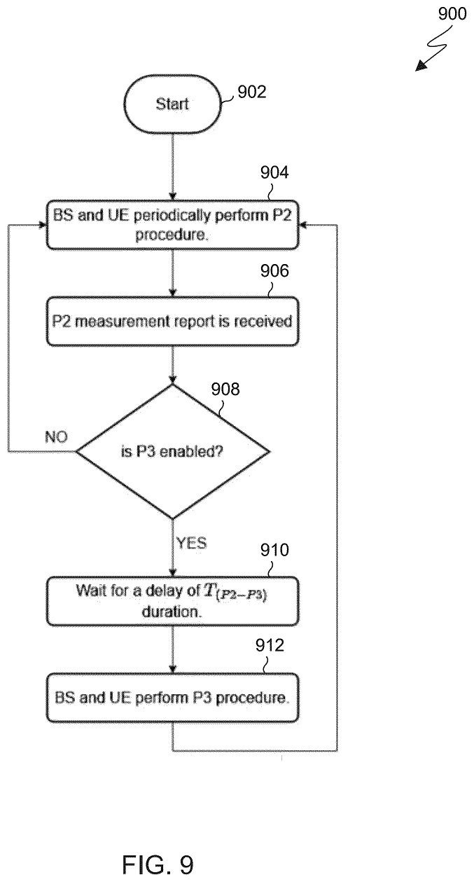

FIG. 9 illustrates an example of a method 900 for P-3 triggering after P-2 with a delay according to embodiments of the present disclosure. For example, method 900 can be performed by the UE 116 and the gNB 102 and/or network 130 in the wireless network 100 of FIG. 1. The embodiment of the example of a method 900 for P-3 triggering after P-2 with a delay shown in FIG. 9 is for illustration only. Other embodiments of the example of a method 900 for P-3 triggering after P-2 with a delay could be used without departing from the scope of this disclosure.

As illustrated in FIG. 9, the method 900 begins at step 902, and proceeds to step 904, where the BS and the UE periodically perform the P-2 procedure. At step 906, a P-2 measurement report is received, and thereafter a determination is made at step 908 whether P-3 is enabled. If P-3 is not enabled, then the method reverts to step 904. If P-3 is enabled, then at step 910, the method waits for a delay of T_{(P2-P3)} duration, and thereafter at step 912, the BS and the UE perform the P-3 procedure, and thereafter the method reverts to step 904. As non-limiting examples, the delay T_{(P2-P3)} could be determined based on the number of UEs served in a cell or the estimated UE movement speed.

In some embodiments, the P-3 can be triggered after every P-2 when the serving network beam is changed.

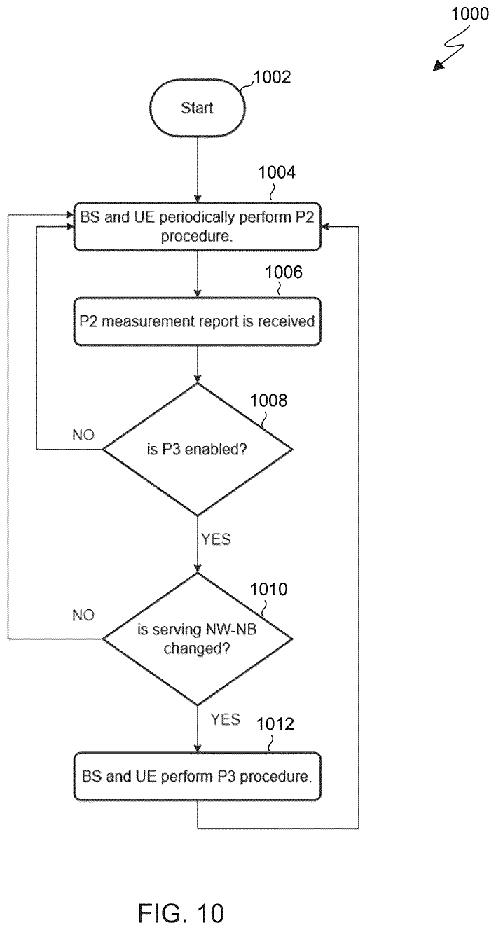

FIG. 10 illustrates an example of a method 1000 for P-3 triggering after P-2 when the serving network narrow beam is changed according to embodiments of the present disclosure. For example, method 1000 can be performed by the UE 116 and the gNB 102 and/or network 130 in the wireless network 100 of FIG. 1. The embodiment of the example of a method 1000 for P-3 triggering after P-2 when the serving network narrow beam is changed shown in FIG. 10 is for illustration only. Other embodiments of the example of a method 1000 for P-3 triggering after P-2 when the serving network narrow beam is changed could be used without departing from the scope of this disclosure.

As illustrated in FIG. 10, the method 1000 begins at step 1002, and proceeds to step 1004, where the BS and the UE periodically perform the P-2 procedure. At step 1006, a P-2 measurement report is received, and thereafter a determination is made at step 1008 whether P-3 is enabled. If P-3 is not enabled, then the method reverts to step 1004. If P-3 is enabled, then at step 1010, a determination is made whether the serving network narrow beam is changed. If the serving network narrow beam is not changed, then the method reverts to step 1004. If the serving network narrow beam is changed, then at step 1012, the BS and the UE perform the P-3 procedure, and thereafter the method reverts to step 1004.

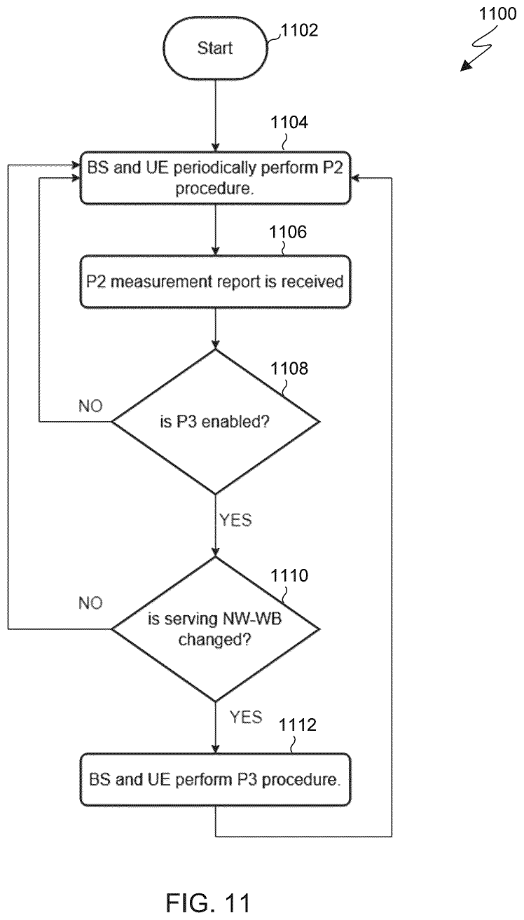

FIG. 11 illustrates an example of a method 1100 for P-3 triggering after P-2 when the serving network wide beam is changed according to embodiments of the present disclosure. For example, method 1100 can be performed by the UE 116 and the gNB 102 and/or network 130 in the wireless network 100 of FIG. 1. The embodiment of the example of a method 1100 for P-3 triggering after P-2 when the serving network wide beam is changed shown in FIG. 11 is for illustration only. Other embodiments of the example of a method 1100 for P-3 triggering after P-2 when the serving network wide beam is changed could be used without departing from the scope of this disclosure.

As illustrated in FIG. 11, the method 1100 begins at step 1102, and proceeds to step 1104, where the BS and the UE periodically perform the P-2 procedure. At step 1106, a P-2 measurement report is received, and thereafter a determination is made at step 1108 whether P-3 is enabled. If P-3 is not enabled, then the method reverts to step 1104. If P-3 is enabled, then at step 1110, a determination is made whether the serving network wide beam is changed. If the serving network wide beam is not changed, then the method reverts to step 1104. If the serving network wide beam is changed, then at step 1112, the BS and the UE perform the P-3 procedure, and thereafter the method reverts to step 1104.

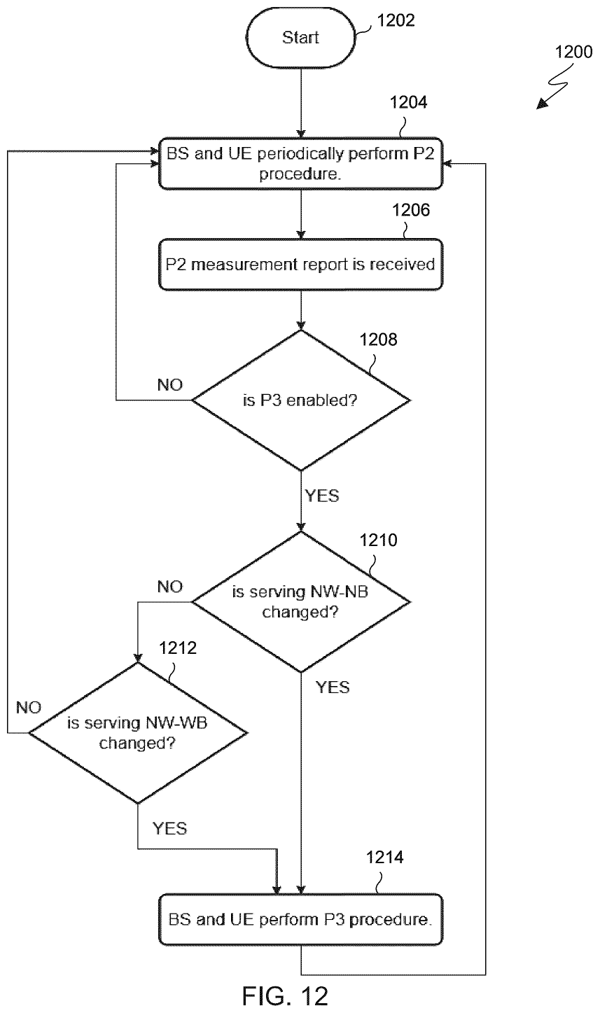

FIG. 12 illustrates an example of a method 1200 for P-3 triggering after P-2 when either the serving network narrow beam or the serving network wide beam is changed according to embodiments of the present disclosure. For example, method 700 can be performed by the UE 116 and the gNB 102 and/or network 130 in the wireless network 100 of FIG. 1. The embodiment of the example of a method 1200 for P-3 triggering after P-2 when either the serving network narrow beam or the serving network wide beam is changed shown in FIG. 12 is for illustration only. Other embodiments of the example of a method 1200 for P-3 triggering after P-2 when either the serving network narrow beam or the serving network wide beam is changed could be used without departing from the scope of this disclosure.

As illustrated in FIG. 12, the method 1200 begins at step 1202, and proceeds to step 1204, where the BS and the UE periodically perform the P-2 procedure. At step 1206, a P-2 measurement report is received, and thereafter a determination is made at step 1208 whether P-3 is enabled. If P-3 is not enabled, then the method reverts to step 1204. If P-3 is enabled, then at step 1210, a determination is made whether the serving network narrow beam is changed. If the serving network narrow beam is changed, then at step 1214, the BS and the UE perform the P-3 procedure, and thereafter the method reverts to step 1204. If the serving network narrow beam is not changed, then at step 1212, a determination is made whether the serving network wide beam is changed. If the serving network wide beam is changed, then at step 1214, the BS and the UE perform the P-3 procedure, and thereafter the method reverts to step 1204. If the serving network wide beam is not changed, the method reverts to step 1204.

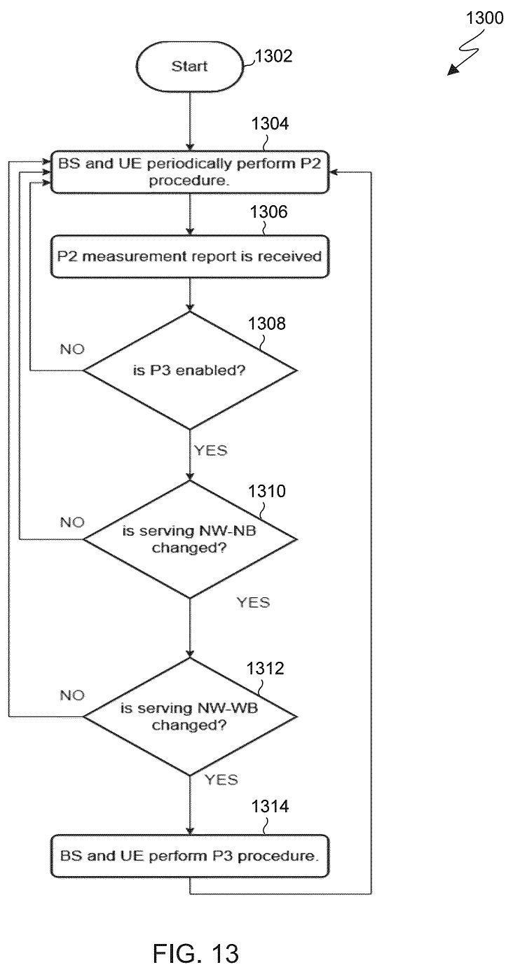

FIG. 13 illustrates an example of a method 1300 for P-3 triggering after P-2 when both the serving network narrow beam and the serving network wide beam are changed according to embodiments of the present disclosure. For example, method 1300 can be performed by the UE 116 and the gNB 102 and/or network 130 in the wireless network 100 of FIG. 1. The embodiment of the example of a method 1300 for P-3 triggering after P-2 when both the serving network narrow beam and the serving network wide beam are changed shown in FIG. 13 is for illustration only. Other embodiments of the example of a method 1300 for P-3 triggering after P-2 when both the serving network narrow beam and the serving network wide beam are changed could be used without departing from the scope of this disclosure.

As illustrated in FIG. 13, the method 1300 begins at step 1302, and proceeds to step 1304, where the BS and the UE periodically perform the P-2 procedure. At step 1306, a P-2 measurement report is received, and thereafter a determination is made at step 1308 whether P-3 is enabled. If P-3 is not enabled, then the method reverts to step 1304. If P-3 is enabled, then at step 1310, a determination is made whether the serving network narrow beam is changed. If the serving network narrow beam is not changed, the method reverts to step 1304. If the serving network narrow beam is changed, then at step 1312, a determination is made whether the serving network wide beam is changed. If the serving network wide beam is not changed, the method reverts to step 1304. If the serving network wide beam is changed, then at step 1314, the BS and the UE perform the P-3 procedure, and thereafter the method reverts to step 1304.

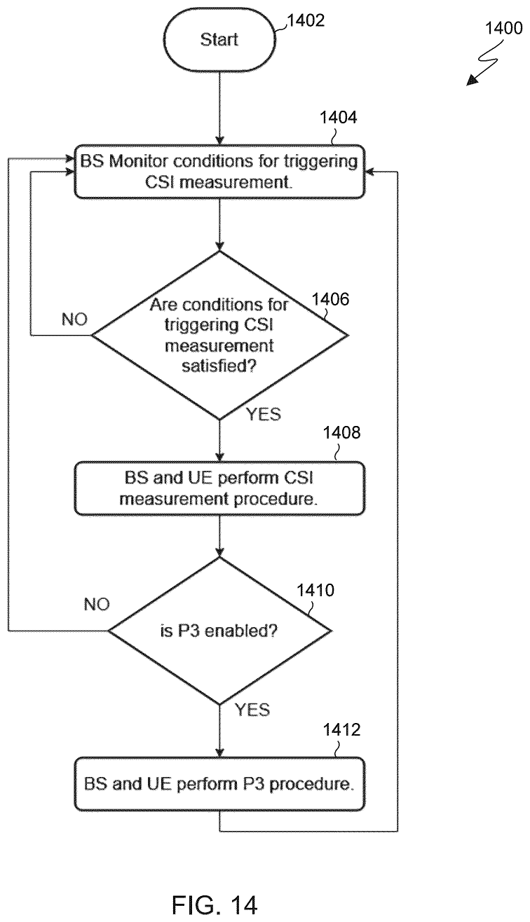

FIG. 14 illustrates an example of a method 1400 for P-3 triggering with CSI measurement where CSI measurement is performed before P-3 according to embodiments of the present disclosure. For example, method 1400 can be performed by the UE 116 and the gNB 102 and/or network 130 in the wireless network 100 of FIG. 1. The embodiment of the example of a method 1400 for P-3 triggering with CSI measurement where CSI measurement is performed before P-3 shown in FIG. 14 is for illustration only. Other embodiments of the example of a method 1400 for P-3 triggering with CSI measurement where CSI measurement is performed before P-3 could be used without departing from the scope of this disclosure.

As illustrated in FIG. 14, the method 1400 begins at step 1402, and proceeds to step 1404, where the BS monitors conditions for triggering CSI measurement. At step 1406, a determination is made whether conditions for triggering CSI measurement are satisfied. If conditions for triggering CSI measurement are not satisfied, then the method reverts to step 1404. If conditions for triggering CSI measurement are satisfied, then at step 1408, the BS and the UE perform a CSI measurement procedure. At step 1410, a determination is made whether P-3 is enabled. If P-3 is not enabled, then the method reverts to step 1404. If P-3 is enabled, then at step 1412, the BS and the UE perform the P-3 procedure, and thereafter the method reverts to step 1404.

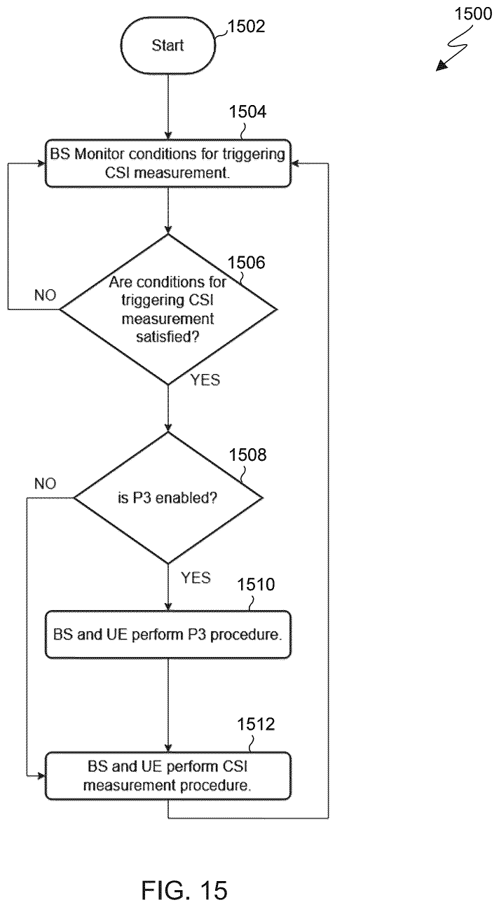

FIG. 15 illustrates an example of a method 1500 for P-3 triggering with CSI measurement where CSI measurement is performed after P-3 according to embodiments of the present disclosure. For example, method 1500 can be performed by the UE 116 and the gNB 102 and/or network 130 in the wireless network 100 of FIG. 1. The embodiment of the example of a method 1500 for P-3 triggering with CSI measurement where CSI measurement is performed after P-3 shown in FIG. 15 is for illustration only. Other embodiments of the example of a method 1500 for P-3 triggering with CSI measurement where CSI measurement is performed after P-3 could be used without departing from the scope of this disclosure.

As illustrated in FIG. 15, the method 1500 begins at step 1502, and proceeds to step 1504, where the BS monitors conditions for triggering CSI measurement. At step 1506, a determination is made whether conditions for triggering CSI measurement are satisfied. If conditions for triggering CSI measurement are not satisfied, then the method reverts to step 1504. If conditions for triggering CSI measurement are satisfied, then at step 1508, a determination is made whether P-3 is enabled. If P-3 is not enabled, the BS and the UE perform a CSI measurement procedure at step 1512, and thereafter the method reverts to step 1504. If P-3 is enabled, then at step 1510, the BS and the UE perform the P-3 procedure, at step 1512 the BS and the UE perform a CSI measurement procedure, and thereafter the method reverts to step 1504.

In some embodiments, the P-3 procedure could be triggered based on the network narrow beam RSRP value reported by the UE after a P-2 procedure

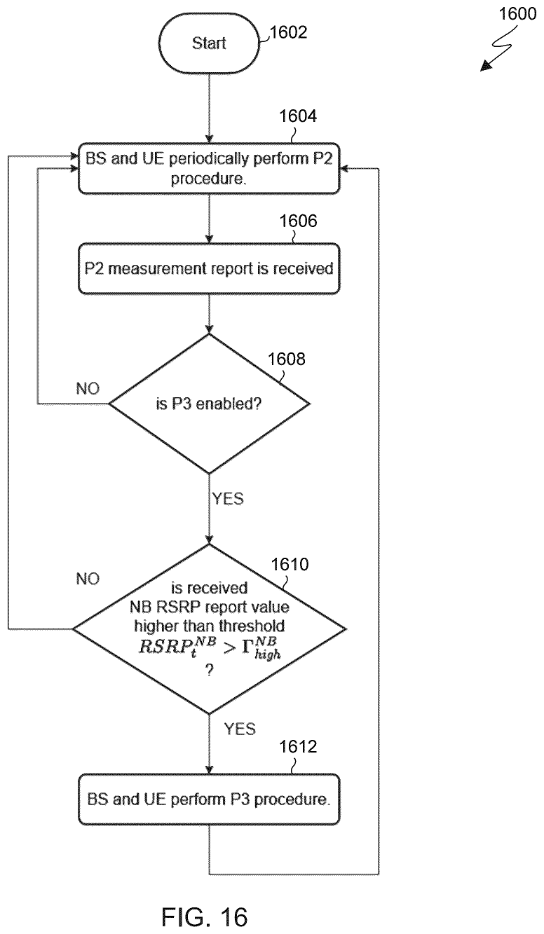

FIG. 16 illustrates an example of a method 1600 for P-3 triggering when the reported narrow beam RSRP is higher than a threshold according to embodiments of the present disclosure. For example, method 1600 can be performed by the UE 116 and the gNB 102 and/or network 130 in the wireless network 100 of FIG. 1. The embodiment of the example of a method 1600 for P-3 triggering when the reported narrow beam RSRP is higher than a threshold shown in FIG. 16 is for illustration only. Other embodiments of the example of a method 1600 for P-3 triggering when the reported narrow beam RSRP is higher than a threshold could be used without departing from the scope of this disclosure.

In some embodiments, the P-3 procedure can be triggered if the NB RSRP value reported by UE is higher than a threshold,

$${high}_{NB}^{} .$$

This type of operation could be desirable when the UE has a good channel i.e., high NB RSRP, and it can achieve higher spectral efficiency if the UE side beam is further improved by the P-3.

As illustrated in FIG. 16, the method 1600 begins at step 1602, and proceeds to step 1604, where the BS and UE periodically perform the P-2 procedure. At step 1606, a P-2 measurement report is received. At step 1608, a determination is made whether P-3 is enabled. If P-3 is not enabled, the method reverts to step 1604. If P-3 is enabled, then at step 1610, a

$${high}_{NB}^{} .$$

determination is made whether the received NB RSRP report value is higher than threshold,

$${high}_{NB}^{} ,$$

step 1604. If the received NB RSRP report value is higher than threshold,

$${Γ}_{high}^{NB} ,$$

then at step 1612, the BS and the UE perform the P-3 procedure, and thereafter the method reverts to step 1604.

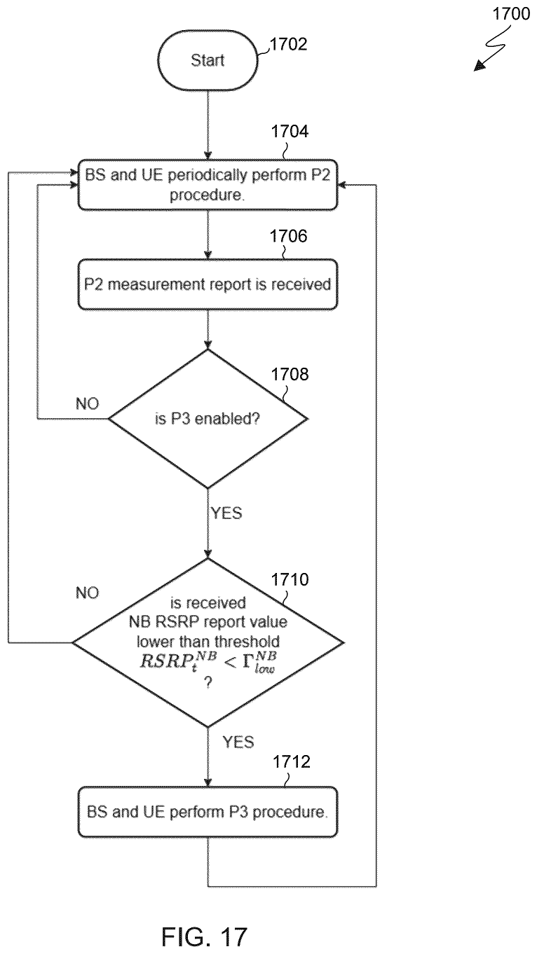

FIG. 17 illustrates an example of a method 1700 for P-3 triggering when the reported narrow beam RSRP is lower than a threshold according to embodiments of the present disclosure. For example, method 1700 can be performed by the UE 116 and the gNB 102 and/or network 130 in the wireless network 100 of FIG. 1. The embodiment of the example of a method 1700 for P-3 triggering when the reported narrow beam RSRP is lower than a threshold shown in FIG. 17 is for illustration only. Other embodiments of the example of a method 1700 for P-3 triggering when the reported narrow beam RSRP is lower than a threshold could be used without departing from the scope of this disclosure.

In some embodiments, the P-3 procedure can be triggered if the NB RSRP value reported by UE is lower than a threshold,

$${Γ}_{low}^{NB} .$$

This type or operation could be desirable when the UE has a bad channel i.e., low NB RSRP, and could potentially lose coverage if a better UE beam is not identified. Therefore, the BS could trigger P-3 to improve the UE side beamforming gain.

As illustrated in FIG. 17, the method 1700 begins at step 1702, and proceeds to step 1704, where the BS and UE periodically perform the P-2 procedure. At step 1706, a P-2 measurement report is received. At step 1708, a determination is made whether P-3 is enabled. If P-3 is not enabled, the method reverts to step 1704. If P-3 is enabled, then at step 1710, a determination is made whether the received NB RSRP report value is lower than threshold,

$${Γ}_{low}^{NB} .$$

If the received NB RSRP report value is not lower than threshold,

$${Γ}_{low}^{NB} ,$$

the method reverts to step 1704. If the received NB RSRP report value is lower than threshold,

$${Γ}_{low}^{NB} ,$$

then at step 1712, the BS and the UE perform the P-3 procedure, and thereafter the method reverts to step 1704.

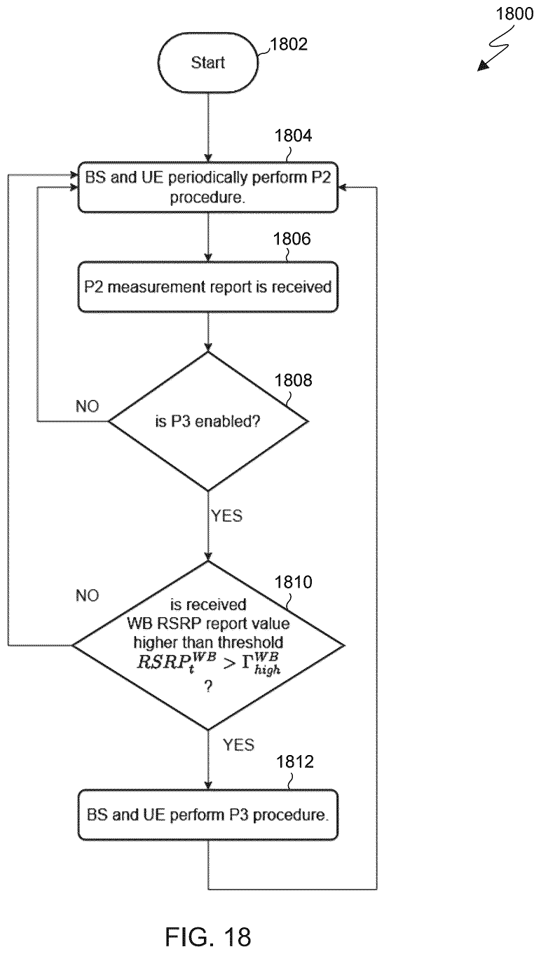

FIG. 18 illustrates an example of a method 1800 for P-3 triggering when the reported wide beam RSRP is higher than a threshold according to embodiments of the present disclosure. For example, method 1800 can be performed by the UE 116 and the gNB 102 and/or network 130 in the wireless network 100 of FIG. 1. The embodiment of the example of a method 1800 for P-3 triggering when the reported wide beam RSRP is higher than a threshold shown in FIG. 18 is for illustration only. Other embodiments of the example of a method 1800 for P-3 triggering when the reported wide beam RSRP is higher than a threshold could be used without departing from the scope of this disclosure.

In some embodiments, the P-3 procedure can be triggered if the WB RSRP value reported by UE is higher than a threshold,

$${Γ}_{high}^{NB} .$$

This type of operation could be desirable when the UE has a good channel i.e., high WB RSRP, and it can achieve higher spectral efficiency if the UE side beam is further improved by the P-3.

As illustrated in FIG. 18, the method 1800 begins at step 1802, and proceeds to step 1804, where the BS and UE periodically perform the P-2 procedure. At step 1806, a P-2 measurement report is received. At step 1808, a determination is made whether P-3 is enabled. If P-3 is not enabled, the method reverts to step 1804. If P-3 is enabled, then at step 1810, a determination is made whether the received WB RSRP report value is higher than threshold,

$${Γ}_{high}^{WB} .$$

If the received WB RSRP report value is not higher than threshold,

$${Γ}_{high}^{WB} ,$$

the method reverts to step 1804. If the received WB RSRP report value is higher than threshold,

$${Γ}_{h i g h}^{W B} ,$$

then, at step 1812, the BS and the UE perform the P-3 procedure, and thereafter the method reverts to step 1804.

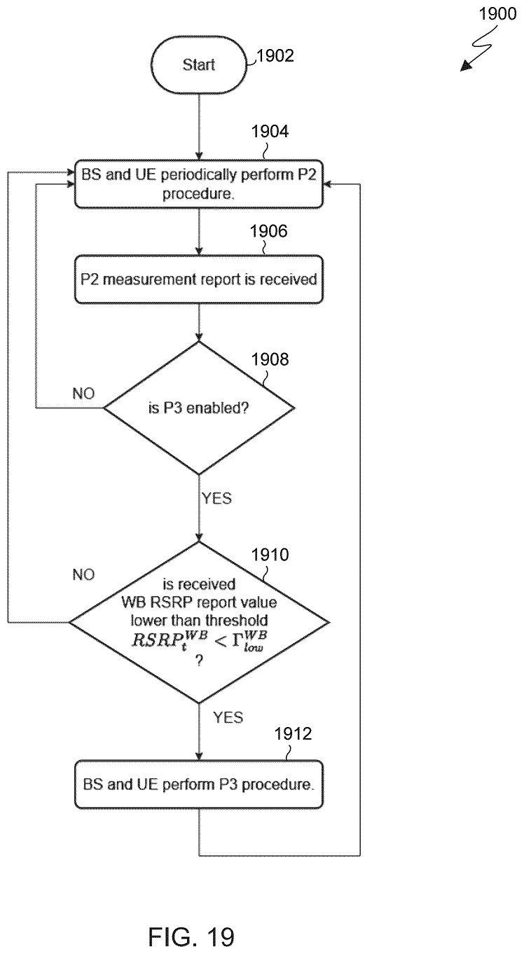

FIG. 19 illustrates an example of a method 1900 for P-3 triggering when the reported wide beam RSRP is lower than a threshold according to embodiments of the present disclosure. For example, method 1900 can be performed by the UE 116 and the gNB 102 and/or network 130 in the wireless network 100 of FIG. 1. The embodiment of the example of a method 1900 for P-3 triggering when the reported wide beam RSRP is lower than a threshold shown in FIG. 19 is for illustration only. Other embodiments of the example of a method 1900 for P-3 triggering when the reported wide beam RSRP is lower than a threshold could be used without departing from the scope of this disclosure.

In some embodiments, the P-3 procedure can be triggered if the WB RSRP value reported by UE is lower than a threshold,

$${Γ}_{low}^{WB} .$$

This type of operation could be desirable when the UE has a bad channel i.e., low WB RSRP, and could potentially lose coverage if a better UE beam is not identified. Therefore, the BS could trigger P-3 to improve the UE side beamforming gain.

As illustrated in FIG. 19, the method 1900 begins at step 1902, and proceeds to step 1904, where the BS and UE periodically perform the P-2 procedure. At step 1906, a P-2 measurement report is received. At step 1908, a determination is made whether P-3 is enabled. If P-3 is not enabled, the method reverts to step 1904. If P-3 is enabled, then at step 1910, a determination is made whether the received WB RSRP report value is lower than threshold,

$${Γ}_{low}^{WB} .$$

If the received WB RSRP report value is not lower than threshold,

$${Γ}_{l o w}^{W B} ,$$

the method reverts to step 1904. If the received WB RSRP report value is lower than threshold,

$${Γ}_{low}^{WB} ,$$

then at step 1912, the BS and the UE perform the P-3 procedure, and thereafter the method reverts to step 1904.

In some embodiments, the lower threshold and higher threshold conditions could be combined. For example, in some embodiments, the P-3 is performed if the reported NB RSRP is either lower than a threshold value

$${Γ}_{low}^{NB}$$

or higher than a threshold value

$${Γ}_{high}^{NB} .$$

As another example, in some embodiments, WB and NB RSRP reports could be used together. As yet another example, in some embodiments, the WB RSRP repot could be used with a lower threshold while the NB RSRP value could be used for higher threshold conditions.

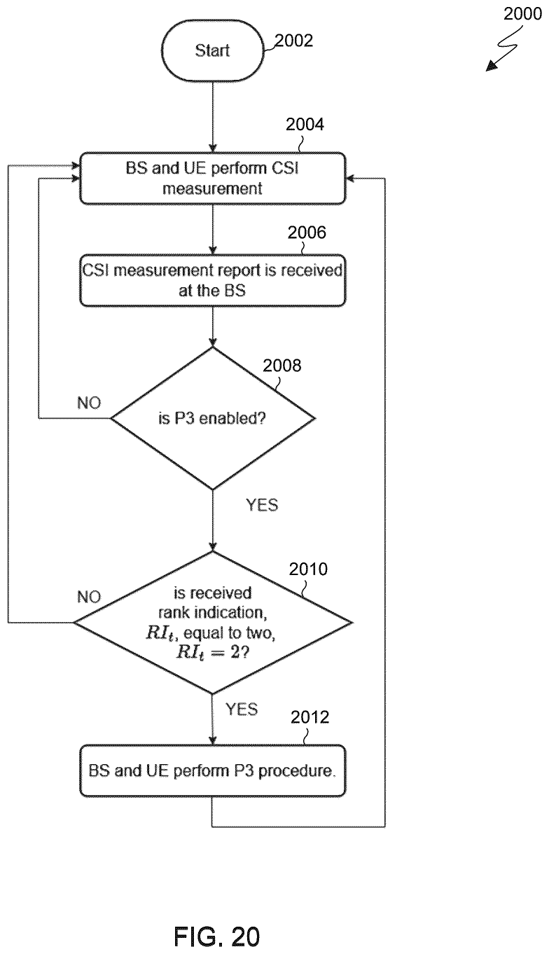

FIG. 20 illustrates an example of a method 2000 for P-3 triggering when the reported rank indication is equal to two according to embodiments of the present disclosure. For example, method 2000 can be performed by the UE 116 and the gNB 102 and/or network 130 in the wireless network 100 of FIG. 1. The embodiment of the example of a method 2000 for P-3 triggering when the reported rank indication is equal to two shown in FIG. 20 is for illustration only. Other embodiments of the example of a method 2000 for P-3 triggering when the reported rank indication is equal to two could be used without departing from the scope of this disclosure.

In some embodiments, the P-3 procedure could be triggered if the rank indication RIₜ in the CSI measurement report at time t is equal to 2, i.e., the data is transmitted over two layers.

As illustrated in FIG. 20, the method 2000 begins at step 2002, and proceeds to step 2004, where the BS and UE perform a CSI measurement procedure. At step 2006, a CSI measurement report is received at the BS. At step 2008, a determination is made whether P-3 is enabled. If P-3 is not enabled, the method reverts to step 2004. If P-3 is enabled, then at step 2010, a determination is made whether the received rank indication RIₜ value is equal to two. If the received rank indication RIₜ value is not equal to two, the method reverts to step 2004. If the received rank indication RIₜ value is equal to two, then at step 2012, the BS and the UE perform the P-3 procedure, and thereafter the method reverts to step 2004.

In some embodiments, the rank indication condition can be combined with previously described embodiments, i.e., ‘after P-2’ condition, or ‘with CSI’ conditions, or other conditions described herein. For example, in some embodiments, the rank indication condition can be combined with periodic P-3 triggering described herein. At each period, an additional condition can be evaluated to check if the most recent CSI report has RIₜ equals 2. If the rank condition is satisfied, the P-3 will be triggered. If the rank condition is not satisfied for this period, the P-3 will be skipped for this particular period. As another example, in some embodiments, the rank indication condition could be combined with RSRP threshold conditions described herein.

As described herein, the P-3 procedure will help the UE determine the best receive beam and improve the SNR. However, the P-3 procedure occupies some transmission opportunities and reduces the data transmission time. There is a trade-off between the SNR improvement and the transmission opportunity reduction. Accordingly, several traffic-based P-3 triggering methods are described herein to achieve the best trade-off. When there is no traffic for one user, it may not be necessary to trigger P-3, considering the P-3 overhead and no benefit from data transmission.

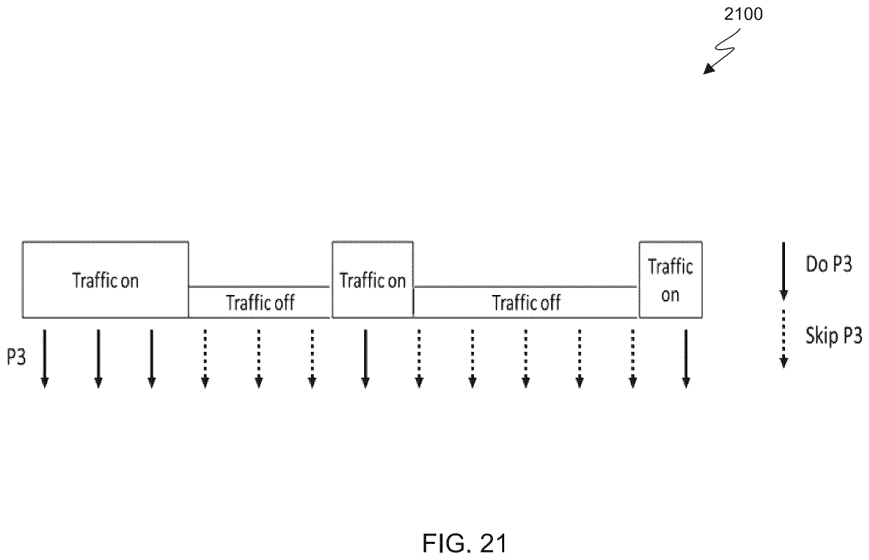

FIG. 21 illustrates an example of a traffic-based scheme 2100 which skips P-3 if there is no traffic according to embodiments of the present disclosure. For example, method 2100 can be performed by the UE 116 and the gNB 102 and/or network 130 in the wireless network 100 of FIG. 1. The embodiment of the example of a traffic-based scheme 2100 which skips P-3 if there is no traffic shown in FIG. 21 is for illustration only. Other embodiments of the example of a traffic-based scheme 2100 which skips P-3 if there is no traffic could be used without departing from the scope of this disclosure.

As illustrated in FIG. 21, the P-3 procedure can be enabled if there is traffic for one user, and disabled if there is no traffic. In some embodiments, the traffic-on and off status can be determined based on the downlink buffer status at the BS and/or the uplink buffer status report from the UE. In some embodiments, the P-3 can be enabled or disabled based on the traffic buffer size. For example, if the traffic buffer size is below a threshold, the P-3 procedure is disabled.

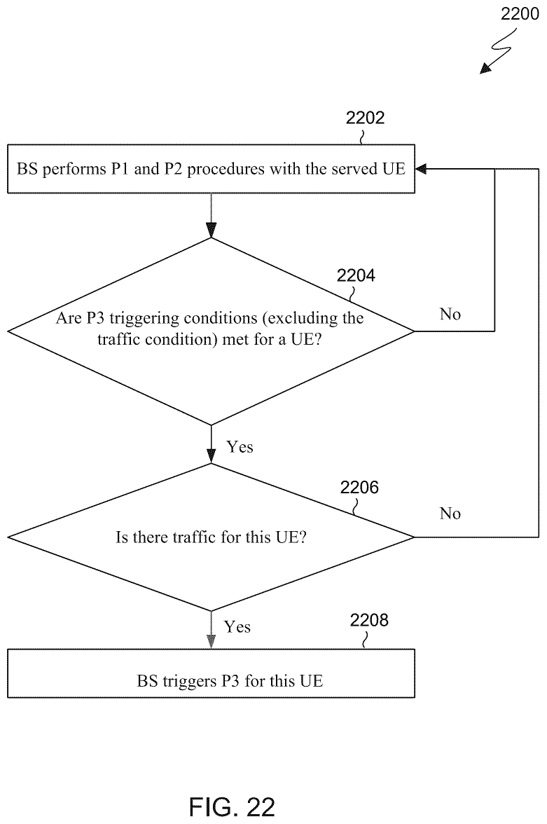

FIG. 22 illustrates an example of a method 2200 of a traffic-based scheme which skips P-3 if there is no traffic according to embodiments of the present disclosure. For example, method 2200 can be performed by the UE 116 and the gNB 102 and/or network 130 in the wireless network 100 of FIG. 1. The embodiment of the example of a method 2200 of a traffic-based scheme which skips P-3 if there is no traffic shown in FIG. 22 is for illustration only. Other embodiments of the example of a method 2200 of a traffic-based scheme which skips P-3 if there is no traffic could be used without departing from the scope of this disclosure.

As illustrated in FIG. 22, the method 2200 begins at step 2202, where the BS performs the P-1 and P-2 procedures with the served UEs. At step 2204, a determination is made whether P-3 triggering conditions (excluding the traffic condition) are satisfied for a UE. If the P-3 triggering conditions (excluding the traffic condition) are not satisfied for the UE, then the method reverts to step 2202. If the P-3 triggering conditions (excluding the traffic condition) are satisfied for the UE, then at step 2206, a determination is made whether there is traffic for the UE. If there is not traffic for the UE, then the method reverts to step 2202. If there is traffic for the UE, then the BS triggers the P-3 for the UE.

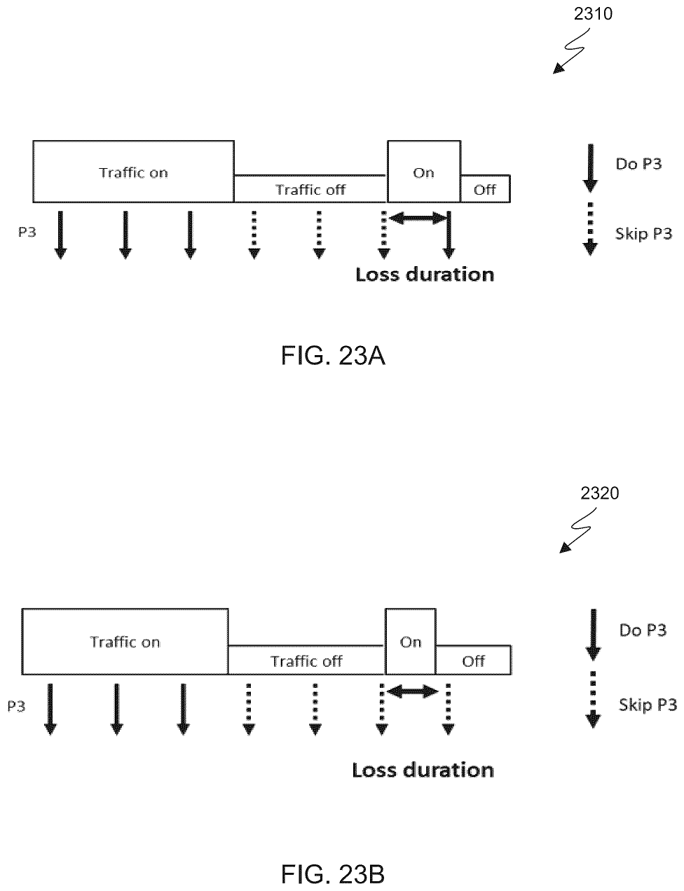

FIGS. 23A and 23B illustrate examples 2310, 2320 of loss duration where the traffic is on but P-3 is off according to embodiments of the present disclosure. The embodiment of the examples 2310, 2320 of loss duration where the traffic is on but P-3 is off shown in FIGS. 23A and 23B is for illustration only. Other embodiments of the examples 2310, 2320 of loss duration where the traffic is on but P-3 is off could be used without departing from the scope of this disclosure.

FIG. 23A illustrates an example 2310 of loss duration where the traffic is back to on but the P-3 is not triggered according to embodiments of the present disclosure. FIG. 23B illustrates an example 2320 of loss duration where the whole traffic-on duration is the loss duration if the traffic is between two P-3 timings (i.e., the P-3 is not triggered) according to embodiments of the present disclosure. For example, the examples 2310, 2320 of loss duration can be implemented by the UE 116 and the gNB 102 and/or network 130 in the wireless network 100 of FIG. 1.

As illustrated in FIGS. 23A and 23B, there is a delay from the start time of the traffic until the traffic-based P-3 algorithm is triggered. There may be SNR loss when the traffic is on but the other triggering conditions of P-3 are not fully met. The duration of the delay is referred to herein as “loss duration”. If the traffic-on time is short, the loss duration can make up a significant portion of the total traffic-on time, as shown in FIG. 23A. Furthermore, the whole traffic-on duration is the loss duration if the traffic is between two potential P-3 timings, as shown in FIG. 23B. Therefore, the traffic-based performance degrades with short traffic durations. On the other hand, the long average traffic-off duration may be detrimental to the traffic-based P-3 performance. If the traffic-off time is long, the beam tracking by P-3 will be skipped multiple times. The long traffic-off time can cause beam misalignment. The age of beam information will be older.

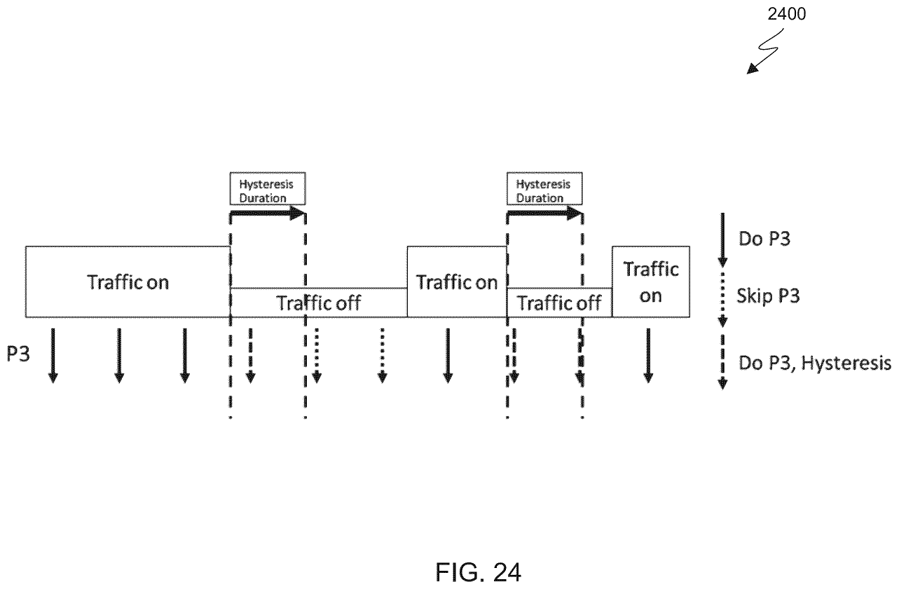

FIG. 24 illustrates an example of a hysteresis scheme 2400 to enable P-3 triggering for some time even after the traffic is off according to embodiments of the present disclosure. For example, hysteresis scheme 2400 can be implemented by the UE 116 and the gNB 102 and/or network 130 in the wireless network 100 of FIG. 1. The embodiment of the example of a hysteresis scheme 2400 to enable P-3 triggering for some time even after the traffic is off shown in FIG. 24 is for illustration only. Other embodiments of the example of a hysteresis scheme 2400 to enable P-3 triggering for some time even after the traffic is off could be used without departing from the scope of this disclosure.

In some embodiments, a hysteresis scheme is adopted to enable P-3 for some time even after the traffic is off. As illustrated in FIG. 24, when traffic is off, the BS is allowed to trigger P-3 if the current time is close to the last time traffic was on.

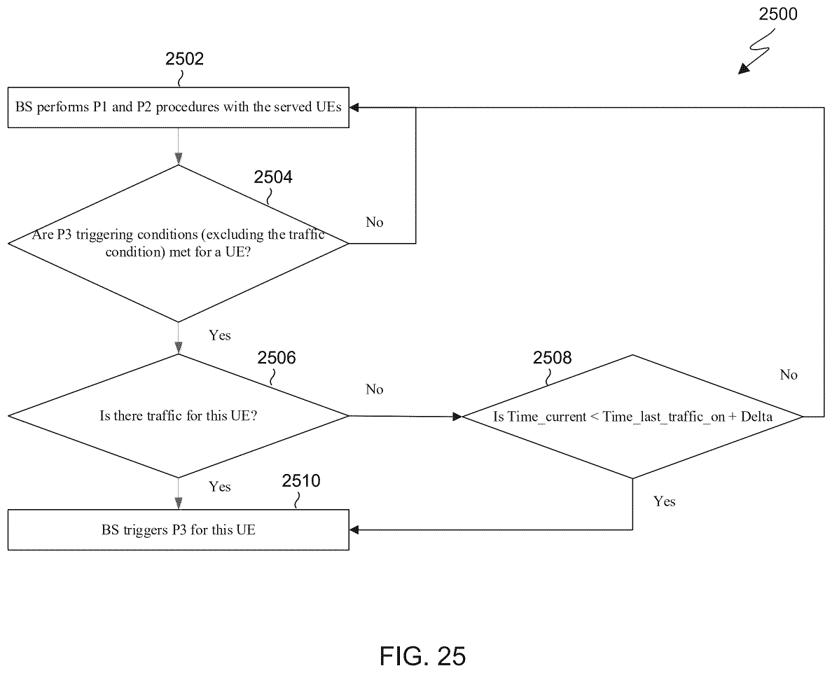

FIG. 25 illustrates an example of a method 2500 of a hysteresis scheme to enable P-3 triggering for some time even after the traffic is off according to embodiments of the present disclosure. For example, method 2500 can be performed by the UE 116 and the gNB 102 and/or network 130 in the wireless network 100 of FIG. 1. The embodiment of the example of a method 2500 of a hysteresis scheme to enable P-3 triggering for some time even after the traffic is off shown in FIG. 25 is for illustration only. Other embodiments of the example of a method 2500 of a hysteresis scheme to enable P-3 triggering for some time even after the traffic is off could be used without departing from the scope of this disclosure.

As illustrated in FIG. 25, the method 2500 begins at step 2502, where the BS performs the P-1 and P-2 procedures with the served UEs. At step 2504, a determination is made whether P-3 triggering conditions (excluding the traffic condition) are satisfied for a UE. If the P-3 triggering conditions (excluding the traffic condition) are not satisfied for the UE, then the method reverts to step 2502. If the P-3 triggering conditions (excluding the traffic condition) are satisfied for the UE, then at step 2506, a determination is made whether there is traffic for the UE. If there is traffic for the UE, then at step 2510, the BS can trigger the P-3 for the UE. If there is not traffic for the UE, then at step 2508, a determination is made whether Time_current<Time_last_traffic_on+Delta, where Delta is a tunable parameter (e.g., 0.1 second, 1 second, 10 seconds), which could be determined from simulation, field trial, and subject to online adjustment. If no, then the method reverts to step 2502. If yes, then the BS can trigger the P-3 for the UE. The hysteresis scheme can achieve a trade-off between robustness to traffic patterns and P-3 overhead savings. It may not turn off P-3 for the case of “short-traffic-on-short-traffic-off”, thus maintaining a stable performance for dynamic traffic cases. On the other hand, it also works in the case of “long-traffic-on-long-traffic-off”, where it can turn off P-3 for most of the traffic-off time.

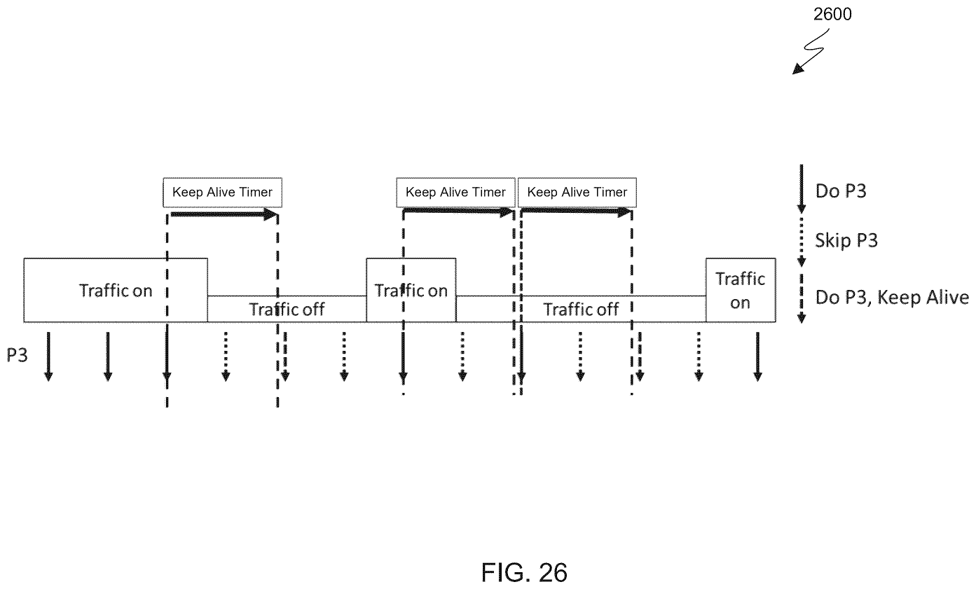

FIG. 26 illustrates an example of a keep alive scheme 2600 to trigger P-3 when the traffic is off for a long duration according to embodiments of the present disclosure. For example, keep-alive scheme 260 can be implemented by the UE 116 and the gNB 102 and/or network 130 in the wireless network 100 of FIG. 1. The embodiment of the example of a keep-alive scheme 2600 to trigger P-3 when the traffic is off for a long duration shown in FIG. 26 is for illustration only. Other embodiments of the example of a keep-alive scheme 2600 to trigger P-3 when the traffic is off for a long duration could be used without departing from the scope of this disclosure.

In some embodiments, as illustrated in FIG. 26, if the traffic is off, but the last P-3 measurement is performed a certain duration ago, the BS triggers P-3. This scheme is referred to herein as a ‘keep alive’ scheme since it keeps refreshing P-3 measurement results even when there is no traffic.

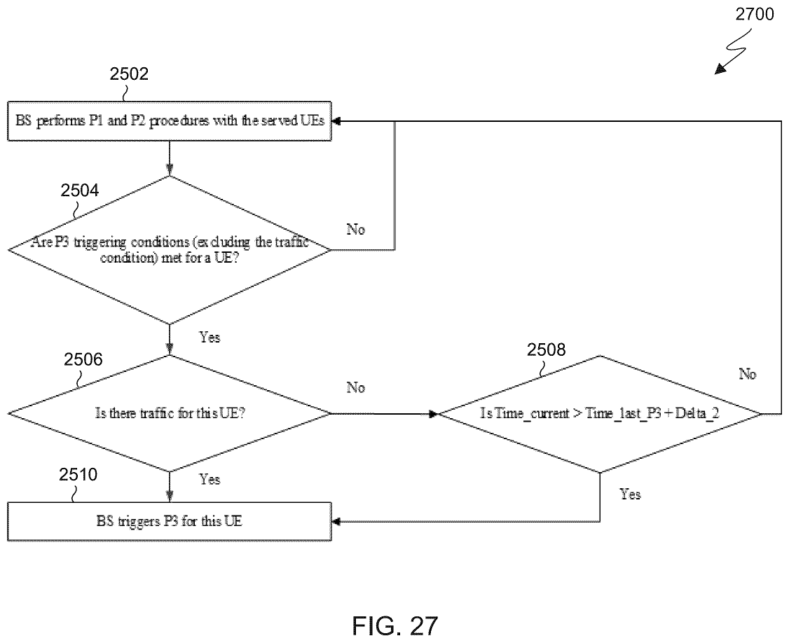

FIG. 27 illustrates an example of a method 2700 of a keep-alive scheme to trigger P-3 when the traffic is off for a long duration according to embodiments of the present disclosure. For example, method 2700 can be performed by the UE 116 and the gNB 102 and/or network 130 in the wireless network 100 of FIG. 1. The embodiment of the example of a method 2700 of a keep-alive scheme to trigger P-3 when the traffic is off for a long duration shown in FIG. 27 is for illustration only. Other embodiments of the example of a method 2700 of a keep-alive scheme to trigger P-3 when the traffic is off for a long duration could be used without departing from the scope of this disclosure.

As illustrated in FIG. 27, the method 2700 begins at step 2702, where the BS performs the P-1 and P-2 procedures with the served UEs. At step 2704, a determination is made whether P-3 triggering conditions (excluding the traffic condition) are satisfied for a UE. If the P-3 triggering conditions (excluding the traffic condition) are not satisfied for the UE, then the method reverts to step 2702. If the P-3 triggering conditions (excluding the traffic condition) are satisfied for the UE, then at step 2706, a determination is made whether there is traffic for the UE. If there is traffic for the UE, then at step 2710, the BS can trigger the P-3 for the UE. If there is not traffic for the UE, then at step 2708, a determination is made whether Time_current>Time_last_P3+Delta_2, where Delta_2 is a keep alive timer. If yes, then the BS can trigger the P-3 for the UE. If no, then the method reverts to step 2702. The keep alive timer should be longer than the normal periodicity of P-3 to reduce the P-3 CSI-RS overhead. For example, when the P-3 periodicity is 240 ms, the keep-alive timer could be set as 500 ms, 5000 ms, and so on. The keep alive timer could be determined from simulation, field trial, and subject to online adjustment. The keep alive scheme improves the performance for scenarios with long traffic off durations, but short traffic on durations.

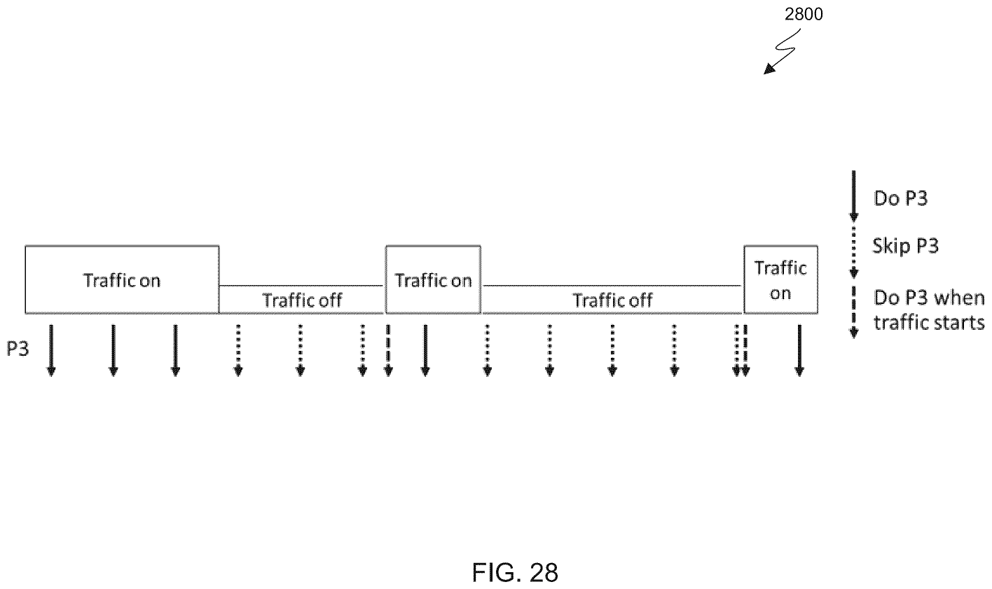

FIG. 28 illustrates an example of a traffic arrival scheme 2800 to trigger P-3 when the traffic is off for a long duration according to embodiments of the present disclosure. For example, traffic arrival scheme 2800 can be implemented by the UE 116 and the gNB 102 and/or network 130 in the wireless network 100 of FIG. 1. The embodiment of the example of a traffic arrival scheme 2800 to trigger P-3 when the traffic is off for a long duration shown in FIG. 28 is for illustration only. Other embodiments of the example of a traffic arrival scheme 2800 to trigger P-3 when the traffic is off for a long duration could be used without departing from the scope of this disclosure.

As illustrated in FIG. 28, in some embodiments, the BS triggers the P-3 procedure as soon as traffic arrivals. The additional triggering at the beginning of traffic-on duration can completely remove the ‘loss duration’ in FIGS. 23A and 23B. The expense is the additional P-3 CSI-RS signaling at the beginning of each traffic on duration.

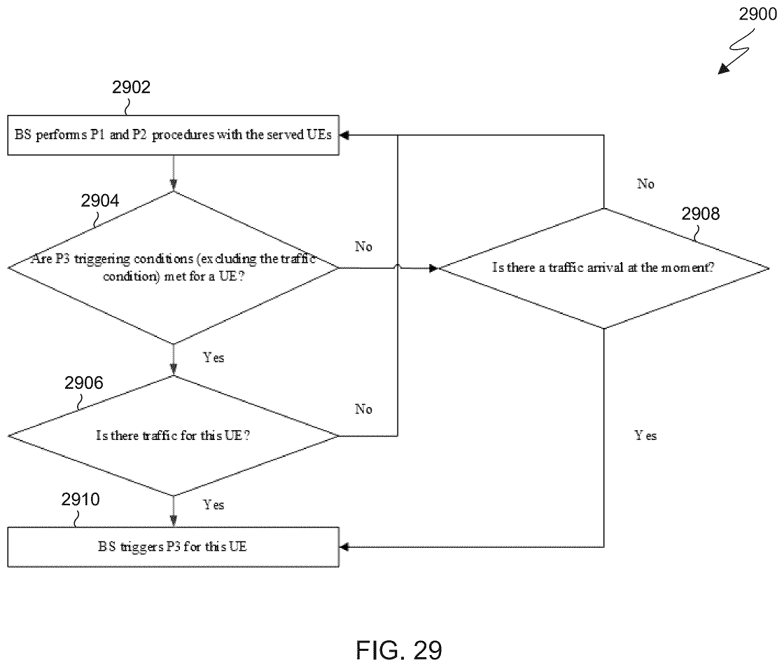

FIG. 29 illustrates an example of a method 2900 of a traffic arrival scheme to trigger P-3 when the traffic is off for a long duration according to embodiments of the present disclosure. For example, method 2900 can be performed by the UE 116 and the gNB 102 and/or network 130 in the wireless network 100 of FIG. 1. The embodiment of the example of a method 2900 of a traffic arrival scheme to trigger P-3 when the traffic is off for a long duration shown in FIG. 29 is for illustration only. Other embodiments of the example of a method 2900 of a traffic arrival scheme to trigger P-3 when the traffic is off for a long duration could be used without departing from the scope of this disclosure.

As illustrated in FIG. 29, the method 2900 begins at step 2902, where the BS performs the P-1 and P-2 procedures with the served UEs. At step 2904, a determination is made whether P-3 triggering conditions (excluding the traffic condition) are satisfied for a UE. If the P-3 triggering conditions (excluding the traffic condition) are not satisfied for the UE, then at step 2908, a determination is made whether there is a traffic arrival at the moment. If there is not a traffic arrival at the moment, the method reverts to step 2902. If there is a traffic arrival at the moment, then at step 2910, the BS can trigger the P-3 for the UE. If at step 2904 the P-3 triggering conditions (excluding the traffic condition) are not satisfied for the UE, then at step 2908, a determination is made whether there is traffic for the UE. If there is not traffic for the UE, then the method reverts to step 2902. If there is traffic for the UE, then at step 2910, the BS can trigger the P-3 for the UE.

In some embodiments, the traffic-arrival P-3 is triggered considering the last P-3 time. If the last P-3 time is close in time, the P-3 can be skipped because the P-3 measurement is not obsolete.

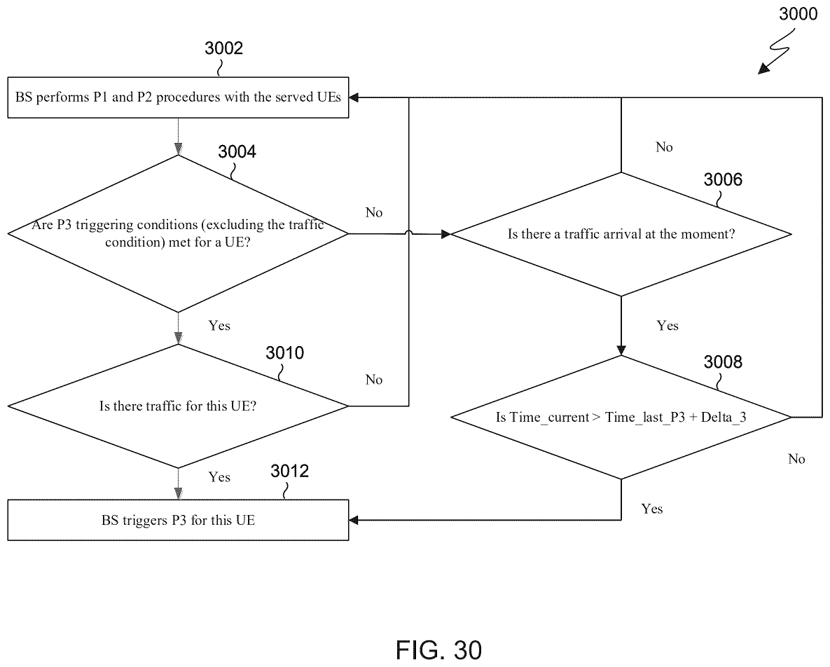

FIG. 30 illustrates an example of a method 3000 of a traffic arrival scheme where the traffic arrival P-3 is triggered when the last P-3 has passed for a certain amount of time according to embodiments of the present disclosure. For example, method 3000 can be performed by the UE 116 and the gNB 102 and/or network 130 in the wireless network 100 of FIG. 1. The embodiment of the example of a method 3000 of a traffic arrival scheme where the traffic arrival P-3 is triggered when the last P-3 has passed for a certain amount of time shown in FIG. 30 is for illustration only. Other embodiments of the example of a method 3000 of a traffic arrival scheme where the traffic arrival P-3 is triggered when the last P-3 has passed for a certain amount of time could be used without departing from the scope of this disclosure.

As illustrated in FIG. 30, the method 3000 begins at step 3002, where the BS performs the P-1 and P-2 procedures with the served UEs. At step 3004, a determination is made whether P-3 triggering conditions (excluding the traffic condition) are satisfied for a UE. If the P-3 triggering conditions (excluding the traffic condition) are not satisfied for the UE, then at step 3006, a determination is made whether there is a traffic arrival at the moment. If there is not a traffic arrival at the moment, the method reverts to step 3002. If there is a traffic arrival at the moment, then at step 3008, a determination is made whether Time_current>Time_last_P3+Delta_3. If yes, then at step 3012, the BS can trigger the P-3 for the UE. If no, then the method reverts to step 3002. If at step 3004 the P-3 triggering conditions (excluding the traffic condition) are satisfied for the UE, then at step 3010, a determination is made whether there is traffic for the UE. If there is not traffic for the UE, then the method reverts to step 3002. If there is traffic for the UE, then at step 3012, the BS can trigger the P-3 for the UE.

In some embodiments, the three schemes described herein including hysteresis, keep-alive and traffic-arrival schemes, can be combined. In one example, the hysteresis and keep-alive scheme can be combined together to maintain the robustness to traffic patterns. The hysteresis works well for the “short-traffic-on-short-traffic-off” cases, while the keep-alive works well for the “short-traffic-on-long-traffic-off”' cases. The hybrid scheme thus works well for all the “short-traffic-on” cases.

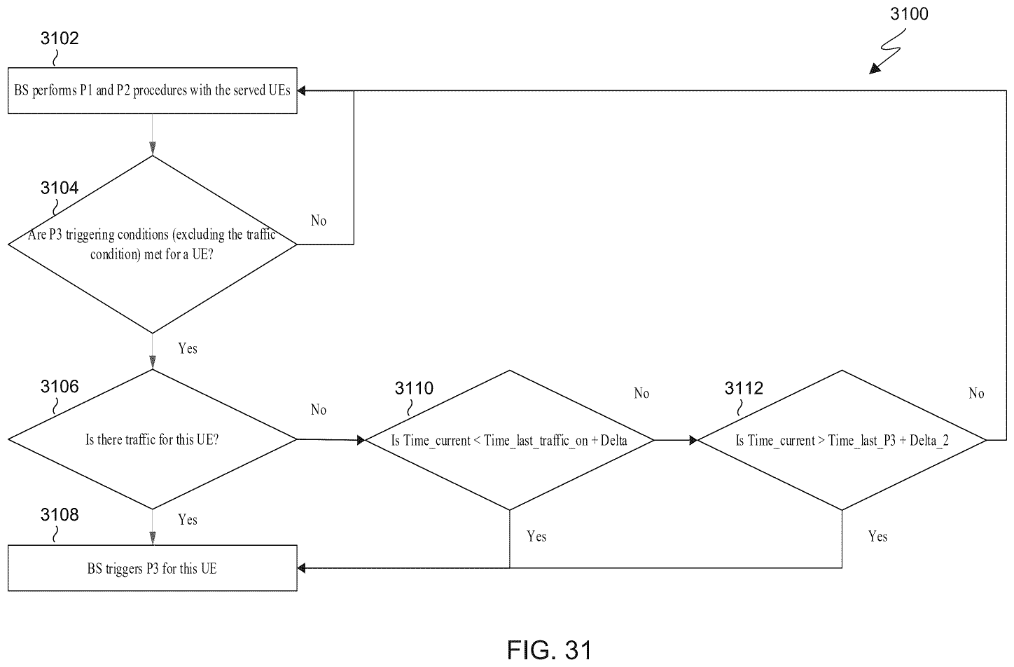

FIG. 31 illustrates an example of a method 3100 of a combination of hysteresis and keep alive scheme according to embodiments of the present disclosure. For example, method 3100 can be performed by the UE 116 and the gNB 102 and/or network 130 in the wireless network 100 of FIG. 1. The embodiment of the example of a method 3100 of a combination of hysteresis and keep alive scheme shown in FIG. 31 is for illustration only. Other embodiments of the example of a method 3100 of a combination of hysteresis and keep alive scheme could be used without departing from the scope of this disclosure.

As illustrated in FIG. 31, the method 3100 begins at step 3102, where the BS performs the P-1 and P-2 procedures with the served UEs. At step 3104, a determination is made whether P-3 triggering conditions (excluding the traffic condition) are satisfied for a UE. If the P-3 triggering conditions (excluding the traffic condition) are not satisfied for the UE, then the method reverts to step 3102. If the P-3 triggering conditions (excluding the traffic condition) are satisfied for the UE, then at step 3106, a determination is made whether there is traffic for the UE. If there is traffic for the UE, then at step 3108, the BS can trigger the P-3 for the UE. If there is not traffic for the UE, then at step 3110, a determination is made whether Time_current<Time_last_traffic_on+Delta. If yes, then at step 3108, the BS can trigger the P-3 for the UE. If no, then at step 3112, a determination is made whether Time_current>Time_last_P3+Delta_2. If yes, then at step 3108, the BS can trigger the P-3 for the UE. If no, then the method reverts to step 3102.

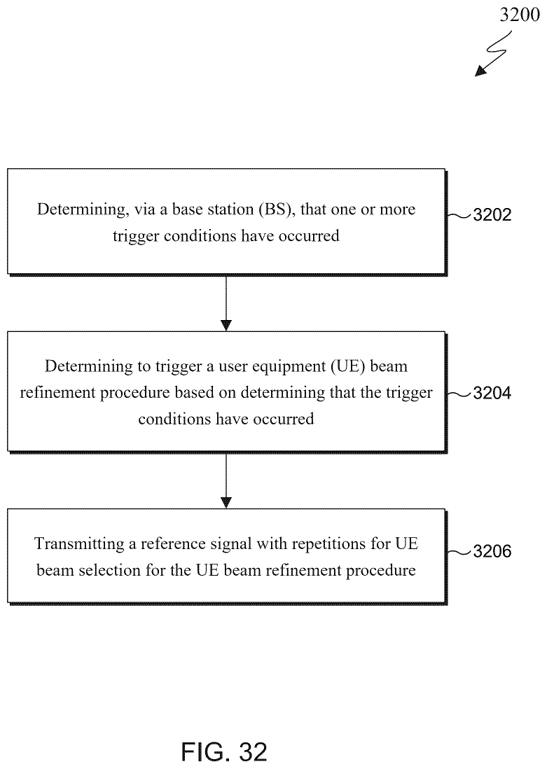

FIG. 32 illustrates an example method 3200 for P-3 triggering according to embodiments of the present disclosure. For example, method 3200 can be performed by the gNB 102 in the wireless network 100 of FIG. 1. The embodiment of an example method 3200 for P-3 triggering shown in FIG. 32 is for illustration only. Other embodiments of an example method 3200 for P-3 triggering could be used without departing from the scope of this disclosure.

As illustrated in FIG. 32, the method 3200 begins at step 3202, and includes determining, via a BS, that one or more trigger conditions have occurred. At step 3204, the method includes determining to trigger a UE beam refinement procedure based on determining that the trigger conditions have occurred. At step 3206, the method includes transmitting a reference signal with repetitions for UE beam selection for the UE beam refinement procedure.

In some embodiments, to determine to trigger the UE beam refinement procedure, the BS is configured to determine to trigger the UE beam refinement procedure periodically. The BS is further configured to transmit, to the UE, configuration information indicating that the UE beam refinement procedure is triggered periodically.

In some embodiments, the BS is configured to perform a BS beam refinement procedure, and to determine to trigger the UE beam refinement procedure periodically, the BS is further configured to determine to trigger the UE beam refinement procedure after performing the BS beam refinement procedure. The BS is further configured to transmit, to the UE, configuration information indicating that the UE beam refinement procedure is triggered after the BS beam refinement procedure.

In some embodiments, the one or more trigger conditions includes a channel state information (CSI) measurement procedure, and to determine to trigger the UE beam refinement procedure, the BS is further configured to determine to trigger the UE beam refinement procedure after the CSI measurement procedure is triggered. The BS is further configured to transmit, to the UE, configuration information indicating that the UE beam refinement procedure is triggered after the CSI measurement procedure is triggered.

In some embodiments, the one or more trigger conditions includes a channel state information (CSI) measurement procedure, and to determine to trigger the UE beam refinement procedure, the BS is further configured to determine to trigger the UE beam refinement procedure before the CSI measurement procedure. The BS is further configured to transmit, to the UE, configuration information indicating that the UE beam refinement procedure is triggered before the CSI measurement procedure.

In some embodiments, the BS is further configured to perform a BS beam refinement procedure, and to determine to trigger the UE beam refinement procedure, the BS is further configured to determine to trigger the UE beam refinement procedure after the BS beam refinement procedure when a network narrow beam is changed or when a network wide beam is changed. The BS is further configured to transmit, to the UE, configuration information indicating that the UE beam refinement procedure is triggered after the BS beam refinement procedure when the network narrow beam is changed or when the network wide beam is changed.

In some embodiments, to determine to trigger the UE beam refinement procedure, the BS is configured to determine to trigger the UE beam refinement procedure based on UE traffic-based conditions. The BS is further configured to transmit, to the UE, configuration information indicating that the UE beam refinement procedure is triggered based on UE traffic-based conditions.

In some embodiments, the UE traffic-based conditions include a hysteresis procedure to enable the UE beam refinement procedure for a duration of time after traffic is off, and to determine to trigger the UE beam refinement procedure, the BS is further configured to determine to trigger the UE beam refinement procedure when traffic is off, and to determine to trigger the UE beam refinement procedure when a current time is within a threshold of a most recent time that traffic was on. The BS is further configured to transmit, to the UE, configuration information indicating that the UE beam refinement procedure is triggered when the current time is within the threshold of a most recent time that traffic was on.

In some embodiments, the UE traffic-based conditions include a keep-alive procedure to enable the UE beam refinement procedure when a most recent UE beam refinement procedure measurement was performed and exceeds a threshold duration ago, and to determine to trigger the UE beam refinement procedure, the BS is further configured to determine to trigger the UE beam refinement procedure when the most recent UE beam refinement procedure measurement was performed and exceeds the threshold duration ago. The BS is further configured to transmit, to the UE, configuration information indicating that the UE beam refinement procedure is triggered when the most recent UE beam refinement procedure measurement was performed and exceeds the threshold duration ago.

In some embodiments, the UE traffic-based conditions include a traffic arrival procedure to enable the UE beam refinement procedure when traffic arrives at the UE, and to determine to trigger the UE beam refinement procedure, the BS is further configured to determine to trigger the UE beam refinement procedure when traffic arrives at the UE. The BS is further configured to transmit, to the UE, configuration information indicating that the UE beam refinement procedure is triggered when traffic arrives at the UE.

The flowcharts herein illustrate example methods or processes that can be implemented in accordance with the principles of the present disclosure and various changes could be made to the methods or processes illustrated in the flowcharts. For example, while shown as a series of steps, various steps could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method comprising:
determining, via a base station (BS), that one or more trigger conditions have occurred;
determining to trigger a user equipment (UE) beam refinement procedure based on determining that the trigger conditions have occurred; and
transmitting a reference signal with repetitions for UE beam selection for the UE beam refinement procedure.

2. The method of claim 1, wherein determining to trigger the UE beam refinement procedure further comprises:
determining to trigger the UE beam refinement procedure periodically; and
transmitting, to the UE, configuration information indicating that the UE beam refinement procedure is triggered periodically.

3. The method of claim 2, further comprising:
performing a BS beam refinement procedure,
wherein determining to trigger the UE beam refinement procedure periodically further comprises:
determining to trigger the UE beam refinement procedure after performing the BS beam refinement procedure; and
transmitting, to the UE, configuration information indicating that the UE beam refinement procedure is triggered after the BS beam refinement procedure.

4. The method of claim 1, wherein:
the one or more trigger conditions includes a channel state information (CSI) measurement procedure; and
determining to trigger the UE beam refinement procedure further comprises:
determining to trigger the UE beam refinement procedure after the CSI measurement procedure is triggered; and
transmitting, to the UE, configuration information indicating that the UE beam refinement procedure is triggered after the CSI measurement procedure is triggered.

5. The method of claim 1, wherein:
the one or more trigger conditions includes a channel state information (CSI) measurement procedure; and
determining to trigger the UE beam refinement procedure further comprises:
determining to trigger the UE beam refinement procedure before the CSI measurement procedure; and
transmitting, to the UE, configuration information indicating that the UE beam refinement procedure is triggered before the CSI measurement procedure.

6. The method of claim 1, further comprising:
performing a BS beam refinement procedure,
wherein determining to trigger the UE beam refinement procedure further comprises:
determining to trigger the UE beam refinement procedure after the BS beam refinement procedure when a network narrow beam is changed or when a network wide beam is changed; and
transmitting, to the UE, configuration information indicating that the UE beam refinement procedure is triggered after the BS beam refinement procedure when the network narrow beam is changed or when the network wide beam is changed.

7. The method of claim 1, wherein:
determining to trigger the UE beam refinement procedure further comprises:
determining to trigger the UE beam refinement procedure based on UE traffic-based conditions; and
transmitting, to the UE, configuration information indicating that the UE beam refinement procedure is triggered based on UE traffic-based conditions.

8. The method of claim 7, wherein:
the UE traffic-based conditions include a hysteresis procedure to enable the UE beam refinement procedure for a duration of time after traffic is off; and
determining to trigger the UE beam refinement procedure further comprises:
determining to trigger the UE beam refinement procedure when traffic is off;
determining to trigger the UE beam refinement procedure when a current time is within a threshold of a most recent time that traffic was on; and
transmitting, to the UE, configuration information indicating that the UE beam refinement procedure is triggered when the current time is within the threshold of a most recent time that traffic was on.

9. The method of claim 7, wherein:
the UE traffic-based conditions include a keep-alive procedure to enable the UE beam refinement procedure when a most recent UE beam refinement procedure measurement was performed and exceeds a threshold duration ago; and
determining to trigger the UE beam refinement procedure further comprises:
determining to trigger the UE beam refinement procedure when the most recent UE beam refinement procedure measurement was performed and exceeds the threshold duration ago; and
transmitting, to the UE, configuration information indicating that the UE beam refinement procedure is triggered when the most recent UE beam refinement procedure measurement was performed and exceeds the threshold duration ago.

10. The method of claim 7, wherein:
the UE traffic-based conditions include a traffic arrival procedure to enable the UE beam refinement procedure when traffic arrives at the UE; and
determining to trigger the UE beam refinement procedure further comprises:
determining to trigger the UE beam refinement procedure when traffic arrives at the UE; and
transmitting, to the UE, configuration information indicating that the UE beam refinement procedure is triggered when traffic arrives at the UE.

11. A base station (BS), comprising:
a processor configured to:
determine that one or more trigger conditions have occurred;
determine to trigger a user equipment (UE) beam refinement procedure based on determining that the trigger conditions have occurred; and
a transceiver operably coupled to the processor, the transceiver configured to transmit a reference signal with repetitions for UE beam selection for the UE beam refinement procedure.

12. The BS of claim 11, wherein:
to determining to trigger the UE beam refinement procedure, the processor is further configured to determine to trigger the UE beam refinement procedure periodically; and
the transceiver is further configured to transmit, to the UE, configuration information indicating that the UE beam refinement procedure is triggered periodically.

13. The BS of claim 12, wherein:
the processor is further configured to perform a BS beam refinement procedure;
to determine to trigger the UE beam refinement procedure periodically, the processor is further configured to determine to trigger the UE beam refinement procedure after performing the BS beam refinement procedure; and
the transceiver is further configured to transmit, to the UE, configuration information indicating that the UE beam refinement procedure is triggered after the BS beam refinement procedure.

14. The BS of claim 11, wherein:
the one or more trigger conditions includes a channel state information (CSI) measurement procedure;
to determine to trigger the UE beam refinement procedure, the processor is further configured to determine to trigger the UE beam refinement procedure after the CSI measurement procedure is triggered; and
the transceiver is further configured to transmit, to the UE, configuration information indicating that the UE beam refinement procedure is triggered after the CSI measurement procedure is triggered.

15. The BS of claim 11, wherein:
the one or more trigger conditions includes a channel state information (CSI) measurement procedure;
to determine to trigger the UE beam refinement procedure, the processor is further configured to determine to trigger the UE beam refinement procedure before the CSI measurement procedure; and
the transceiver is further configured to transmit, to the UE, configuration information indicating that the UE beam refinement procedure is triggered before the CSI measurement procedure.

16. The BS of claim 11, wherein:
the processor is further configured to perform a BS beam refinement procedure;
to determine to trigger the UE beam refinement procedure, the processor is further configured to determine to trigger the UE beam refinement procedure after the BS beam refinement procedure when a network narrow beam is changed or when a network wide beam is changed; and
the transceiver is further configured to transmit, to the UE, configuration information indicating that the UE beam refinement procedure is triggered after the BS beam refinement procedure when the network narrow beam is changed or when the network wide beam is changed.

17. The BS of claim 11, wherein:
to determine to trigger the UE beam refinement procedure, the processor is further configured to determine to trigger the UE beam refinement procedure based on UE traffic-based conditions; and
the transceiver is configured to transmit, to the UE, configuration information indicating that the UE beam refinement procedure is triggered based on UE traffic-based conditions.

18. The BS of claim 17, wherein:
the UE traffic-based conditions include a hysteresis procedure to enable the UE beam refinement procedure for a duration of time after traffic is off;
to determine to trigger the UE beam refinement procedure, the processor is further configured to:
determine to trigger the UE beam refinement procedure when traffic is off; and
determine to trigger the UE beam refinement procedure when a current time is within a threshold of a most recent time that traffic was on; and
the transceiver is further configured to transmit, to the UE, configuration information indicating that the UE beam refinement procedure is triggered when the current time is within the threshold of a most recent time that traffic was on.

19. The BS of claim 17, wherein:
the UE traffic-based conditions include a keep-alive procedure to enable the UE beam refinement procedure when a most recent UE beam refinement procedure measurement was performed and exceeds a threshold duration ago;
to determine to trigger the UE beam refinement procedure, the processor is further configured to determine to trigger the UE beam refinement procedure when the most recent UE beam refinement procedure measurement was performed and exceeds the threshold duration ago; and
the transceiver is further configured to transmit, to the UE, configuration information indicating that the UE beam refinement procedure is triggered when the most recent UE beam refinement procedure measurement was performed and exceeds the threshold duration ago.

20. The BS of claim 17, wherein:
the UE traffic-based conditions include a traffic arrival procedure to enable the UE beam refinement procedure when traffic arrives at the UE;
to determine to trigger the UE beam refinement procedure, the processor is further configured to determine to trigger the UE beam refinement procedure when traffic arrives at the UE; and
the transceiver is further configured to transmit, to the UE, configuration information indicating that the UE beam refinement procedure is triggered when traffic arrives at the UE.
